(19) United States
(12) Patent Application Publication
(10) Pub. No.: US 2022/0169828 A1
(43) Pub. Date: Jun. 2, 2022

(54) COMPOSITIONS AND METHODS FOR PROTECTING ORGANIC POLYMERIC MATERIALS FROM DISCOLORATION DUE TO EXPOSURE TO UV-C LIGHT

(71) Applicant: CYTEC INDUSTRIES INC., Princeton, NJ (US)

(72) Inventors: Jerry Mon-Hei ENG, Wilton, CT (US); Ram B. Gupta, Stamford, CT (US); Xin Li, Stamford, CT (US); Jian-Yang Cho, Easton, CT (US); Kyle O'Connor, Stamford, CT (US); Thomas Santamaria, Norwalk, CT (US); Min Wang, Darien, CT (US)

(73) Assignee: CYTEC INDUSTRIES INC., Princeton, NJ (US)

(21) Appl. No.: 17/535,060

(22) Filed: Nov. 24, 2021

Related U.S. Application Data
(60) Provisional application No. 63/190,431, filed on May 19, 2021.
(60) Provisional application No. 63/118,807, filed on Nov. 27, 2020.

(51) Int. Cl. C08K 5/00; C08L 23/06; C08L 23/12; C08K 5/132; C08K 5/529; C08K 5/3492; C08K 5/3435; C08K 5/3462

(52) U.S. Cl. CPC C08K 5/005; C08L 23/06; C08L 23/12; C08K 5/132; C08L 2201/08; C08K 5/3492; C08K 5/3435; C08K 5/3462; C08K 5/529

(57) ABSTRACT

Polymer compositions for making a stabilized polymeric articles that are resistant to discoloration upon exposure to UV-C light having: (i) an organic polymeric material; and (ii) a hindered phenol, organic phosphite, or a combination thereof, with the provisos that: (a) the OH group on the aromatic ring of the hindered phenol is flanked by two tertiary hydrocarbyl groups, and (b) the organic phosphite does not have any —OAr group linked directly to the P atom of the phosphite, wherein Ar represents an unsubstituted or substituted aryl group, are provided herein. Reduced discoloration is associated with the use of specific hindered phenols and the organic phosphites compared to other hindered phenols and organic phosphites, even in the absence of other polymer additives including UV absorbers, hindered amine light stabilizers (HALS), metal oxides and/or barium salts. Methods of reducing discoloration of an organic polymeric material upon exposure to UV-C light are also provided, wherein such methods include the step of adding to the organic polymeric material a stabilizing amount of hindered phenol, organic phosphite, or a combination thereof.

### RELATED APPLICATIONS

This application claims priority to U.S. Provisional Application Nos. 63/118,807 filed Nov. 27, 2020 (Docket No. CYT 2020-005-US-PSP), and 63/190,431 filed May 19, 2021 (Docket No. CYT 2020-005-US-PSP2), each of which is incorporated herein by reference in its entirety. This application is also related in subject matter and ownership to U.S. Provisional Application Nos. 63/118,809 filed Nov. 27, 2020 (Docket No. CYT 2020-006-US-PSP), and 63/190,443 filed May 19, 2021 (Docket No. 2020-006-US-PSP2).

### BACKGROUND OF THE TECHNOLOGY AND RELATED ART

### Field of the Technology

The present disclosure generally relates to protecting organic polymeric materials and stabilized polymeric articles made therefrom from the deleterious effects of exposure to UV-C light. More particularly, the present disclosure relates to certain classes of antioxidants and their use in organic polymeric materials for making stabilized polymeric articles, wherein such antioxidants are especially effective in protecting the polymeric articles from the discoloration caused by exposure to germicidal UV-C light.

### Description of the Related Art

Most polymeric organic materials undergo photodegradation when exposed to UV radiation, leading to irreversible chemical changes. These changes adversely affect the physical properties of the polymeric organic materials. Exposure to UV radiation is also detrimental to human skin, and leads to sunburn and skin cancer. Ultraviolet radiation ranges from 100 to 400 nm, and is classified in three sub-regions, viz., 100 to 280 nm (UV-C), 280 to 320 nm (UV-B) and 320 to 400 nm (UV-A). The primary source of UV radiation is sunlight. Solar radiation in the UV-C range does not reach Earth's surface as it gets absorbed by the ozone layer of the stratosphere and by oxygen in the layers above. Thus, immense efforts have been made over the past more than 60 years to develop stabilizers to protect organic polymeric materials and human skin from the deleterious effects of UV-B and UV-A radiation. It is no surprise though that stabilization against UV-C light has largely been ignored, because it was never an issue. However, with the spread of the novel coronavirus COVID-19 the world over, scientists have been endeavoring to reduce transmission in various ways, including disinfecting various objects or belongings with UV-C radiation, which is germicidal. Within a short period of time there has been an exponential growth in utilization of UV-C light irradiation as a disinfectant tool, mainly for indoor applications. Various UV-C devices are being fabricated and used for indoor applications, e.g., for disinfection in medical buildings/hospitals; various modes of transportation, such as, airplanes, trains, automobiles, buses (including stations and airports); commercial and residential interiors including retail stores, restaurants, bars; indoor equipment including furniture, paints, personal protective equipment (PPE), carpets and textiles, and electrical and electronic devices, etc.

The preferred UV-C wavelength range for disinfection is considered to be between 200 to 280 nm, and the especially preferred range is 222 to 254 nm. It has been demonstrated that UV-C exposure effectively and efficiently inactivates microorganisms, including the COVID-19 virus. However, there appears to be a lack of deeper understanding of what adverse effects UV-C exposure has on organic polymeric materials or articles manufactured with these materials. The polymeric organic materials used for indoor applications and manufactured articles do not normally require stabilizers to protect against UV-A and UV-B radiation, because of the limited exposure to UV-A and UV-B from sunlight indoors. Instead, polymeric organic materials used for indoor articles routinely use processing additives, especially antioxidants, e.g., organic phosphites and hindered phenols, to prevent degradation and color generation during exposure to the high temperatures required for processing and formation of the manufactured polymeric articles. However, with the indoor use of UV-C germicidal light, it is important to address whether the polymeric articles made from organic polymeric materials and antioxidants used for processing will have any deleterious effects from UV-C exposure. Particularly concerning is the fact that UV-C radiation is of higher energy than UV-A and UV-B, and may be more harmful to the organic polymeric material. There is also a lack of understanding of UV-C exposure stability and what effect UV-C exposure has on the antioxidants used to protect polymeric organic materials against degradation from both processing UV-A and UV-B light.

While CN 111 286 116 discloses a UV-C irradiation-resistant polypropylene/polyethylene weather-resistant composite material, it is composed of numerous raw materials that unnecessarily add to the cost of the solution and, thus, do not make it practical for widespread industrial use amongst varied applications.

JP 2000086821 also discloses a composition that is described as being excellent in discoloration (yellowing) resistance to ultraviolet rays of a wavelength below 300 nm, but the composition is limited to use in polychloroprene latex compositions.

Thus, there is an urgent need for a stabilization solution to protect polymeric organic materials, as well as articles of manufacture made from organic polymeric materials, from exposure to UV-C radiation. There is also a need for a stabilization solution that reduces discoloration of organic polymeric material upon repeated or prolonged exposure to UV-C light. Such stabilizer solutions would be a useful advance in the art and could find rapid acceptance by industry.

### SUMMARY OF THE DISCLOSURE

The present disclosure provides polymer compositions for making stabilized polymeric articles that are resistant to discoloration upon repeated or prolonged exposure to UV-C (190-280 nm) light, wherein the polymer compositions include, but are not limited to: (i) an organic polymeric material; and (ii) a hindered phenol, organic phosphite, or a combination thereof, with the provisos that: (a) the OH group on the aromatic ring of the hindered phenol is flanked by two tertiary hydrocarbyl groups, and (b) the organic phosphite does not have any —OAr group linked directly to the P atom of the phosphite compound, wherein Ar represents an unsubstituted or substituted aryl group.

The instant disclosure also provides stabilized polymeric articles including the polymer compositions described herein. Reduced discoloration is associated with the use of specific hindered phenols, the organic phosphite, or combinations thereof disclosed herein compared to other hindered phenols and organic phosphites, even in the absence of other polymer additives including UV absorbers, hindered amine light stabilizers (HALS), metal oxides and/or barium salts.

Further provided are methods of reducing discoloration of an organic polymeric material upon repeated or prolonged exposure to UV-C (190-280 nm) light, which method includes adding a stabilizing amount of the hindered phenol, an organic phosphite, or a combination thereof described herein to the organic polymeric material, wherein reduced discoloration is associated with the use of specific hindered phenols and the organic phosphites compared to other hindered phenols and organic phosphites.

This summary may not list all characteristics or elements of the instant disclosure, and subcombinations of elements may also constitute an invention. These and other objects, features, and advantages of the invention will become apparent from the following detailed description taken in conjunction with the accompanying Examples and Drawings.

### BRIEF DESCRIPTION OF THE DRAWINGS

FIG. 1A is a photograph showing color change of the hindered phenol antioxidant, CYANOX™ 1790, from white to yellow (unfavorable), as described in Example 2, Sample 3-1.

FIG. 1B is a photograph showing color change of the hindered phenol antioxidant, IRGANOX™ 3114, from white to blue (more favorable), as described in Example 2, Sample 3-2.

FIG. 1C is a photograph showing color change of the hindered phenol antioxidant, IRGANOX™ 1076, from white to blue (more favorable), as described in Example 2, Sample 3-3.

FIG. 1D is a photograph showing color change of the hindered phenol antioxidant, IRGANOX™ 1010, from white to light blue (most favorable), as described in Example 2, Sample 3-4.

FIG. 1E is a photograph showing color change of the hindered phenol antioxidant, IRGANOX™ 1024, from white to blue (more favorable), as described in Example 2, Sample 3-5.

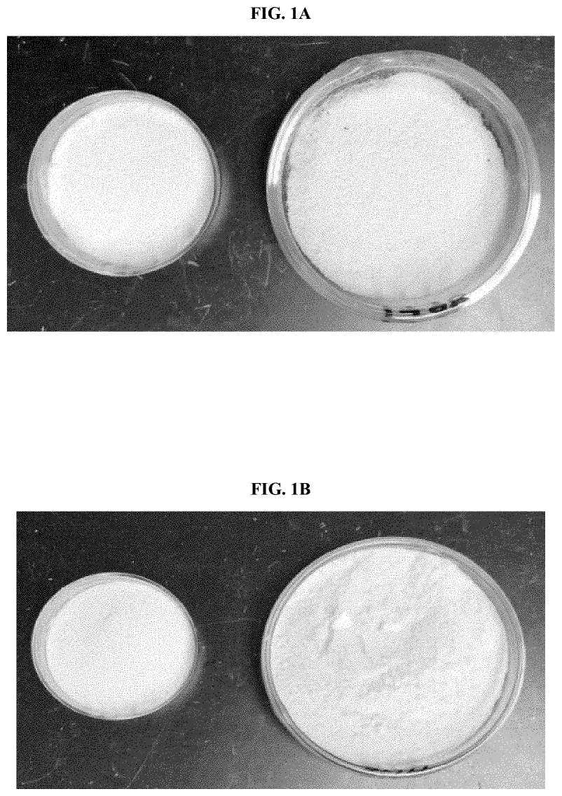

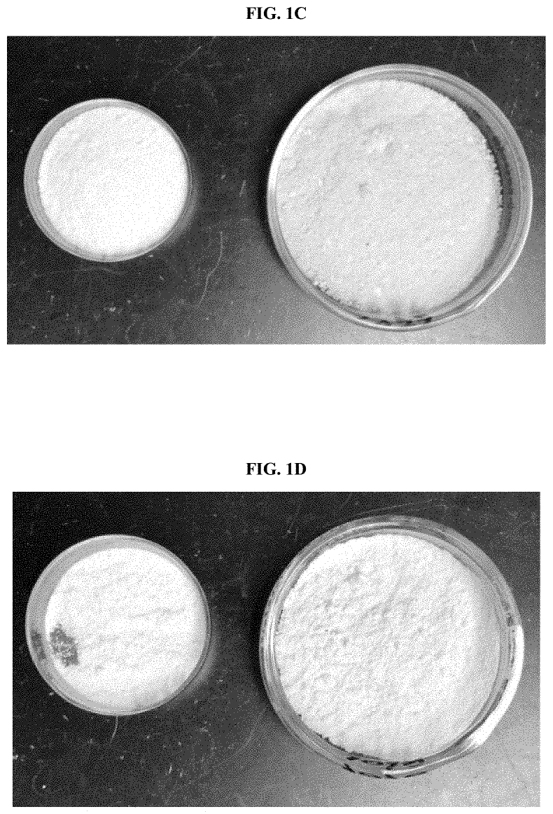

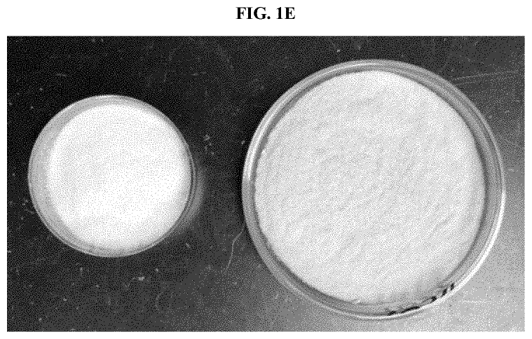

### DETAILED DESCRIPTION OF THE DISCLOSURE

The present inventors have discovered that certain types of hindered phenols and organic phosphites are particularly useful to make polymeric articles resistant to discoloration upon repeated or prolonged exposure to UV-C light. When neat, the hindered phenols disclosed herein turn from white to blue instead of white to yellow upon exposure to UV-C light. Moreover, when formulated with organic polymeric materials, the specific hindered phenols and organic phosphites disclosed herein exhibit reduced discoloration compared to other hindered phenols and organic phosphites, even in the absence of other polymer additives including UV absorbers, hindered amine light stabilizers (HALS), metal oxides and/or barium salts.

### Definitions

As employed herein, the following terms are provided to assist the reader. Unless otherwise defined, all terms of art, notations and other scientific terminology used herein are intended to have the meanings commonly understood by those of skill in the chemical arts.

Throughout this specification the terms and substituents retain their definitions. A comprehensive list of abbreviations utilized by organic chemists (i.e., persons of ordinary skill in the art) appears in the first issue of each volume of the Journal of Organic Chemistry. The list, which is typically presented in a table entitled “Standard List of Abbreviations” is incorporated herein by reference.

The term “hydrocarbyl” is a generic term encompassing aliphatic, alicyclic and aromatic groups having an all-carbon backbone and consisting of carbon and hydrogen atoms, except where otherwise stated. In certain cases, as defined herein, one or more of the carbon atoms making up the carbon backbone may be replaced by a specified atom or group of atoms. Examples of hydrocarbyl groups include alkyl, cycloalkyl, cycloalkenyl, carbocyclic aryl, alkenyl, alkynyl, alkylcycloalkyl, cycloalkylalkyl, cycloalkenylalkyl, and carbocyclic aralkyl, alkaryl, aralkenyl and aralkynyl groups. Such groups can be optionally substituted by one or more substituents as defined herein. Accordingly, the chemical groups or moieties discussed in the specification and claims should be understood to include the substituted or unsubstituted forms. The examples and preferences expressed below apply to each of the hydrocarbyl substituent groups or hydrocarbyl-containing substituent groups referred to in the various definitions of substituents for compounds of the formulas described herein unless the context indicates otherwise.

Preferred non-aromatic hydrocarbyl groups are saturated groups such as alkyl and cycloalkyl groups. Generally, and by way of example, the hydrocarbyl groups can have up to fifty carbon atoms, unless the context requires otherwise. Hydrocarbyl groups with from 1 to 30 carbon atoms are preferred. Within the sub-set of hydrocarbyl groups having 1 to 30 carbon atoms, particular examples are C₁₋₂₀ hydrocarbyl groups, such as C₁₋₁₂ hydrocarbyl groups (e.g., C₁₋₆ hydrocarbyl groups or C₁₋₄ hydrocarbyl groups), specific examples being any individual value or combination of values selected from C₁ through C₃₀ hydrocarbyl groups.

Alkyl is intended to include linear, branched, or cyclic hydrocarbon structures and combinations thereof. Lower alkyl refers to alkyl groups of from 1 to 6 carbon atoms, preferably from 1 to 4 carbon atoms. Examples of lower alkyl groups include methyl, ethyl, propyl, isopropyl, butyl, s- and t-butyl, pentyl, hexyl or cyclohexyl and the like. Preferred alkyl groups are those of C₃₀ or below.

Alkoxy or alkoxyalkyl refers to groups of from 1 to 20 carbon atoms of a straight, branched, cyclic configuration and combinations thereof attached to the parent structure through an oxygen. Examples include methoxy, ethoxy, propoxy, isopropoxy, cyclopropyloxy, cyclohexyloxy and the like.

Acyl refers to formyl and to groups of 1, 2, 3, 4, 5, 6, 7, 8, 9, 10, 11 and 12 carbon atoms of a straight, branched, cyclic configuration, saturated, unsaturated and aromatic and combinations thereof, attached to the parent structure through a carbonyl functionality. Examples include acetyl, benzoyl, propionyl, isobutyryl, tert-butoxycarbonyl, benzyloxycarbonyl and the like. Lower acyl refers to acyl groups containing one to six carbons.

References to “carbocyclic” or “cycloalkyl” groups as used herein shall include both aromatic and non-aromatic ring systems, unless the context indicates otherwise. Thus, for example, the term includes within its scope aromatic, non-aromatic, unsaturated, partially saturated and fully saturated carbocyclic ring systems. In general, such groups may be monocyclic or bicyclic and may contain, for example, 3 to 12 ring members, more usually 5 to 10 ring members. Examples of monocyclic groups are groups containing 3, 4, 5, 6, 7, and 8 ring members, more usually 3 to 7, and preferably 5 or 6 ring members. Examples of bicyclic groups are those containing 8, 9, 10, 11 and 12 ring members, and more usually 9 or 10 ring members. Examples of non-aromatic carbocycle/cycloalkyl groups include c-propyl, c-butyl, c-pentyl, c-hexyl, and the like. Examples of C₇ to C₁₀ polycyclic hydrocarbons include ring systems such as norbornyl and adamantyl.

Aryl (carbocyclic aryl) refers to a 5- or 6-membered aromatic carbocycle ring containing; a bicyclic 9- or 10-membered aromatic ring system; or a tricyclic 13- or 14-membered aromatic ring system. The aromatic 6- to 14-membered carbocyclic rings include, e.g., substituted or unsubstituted phenyl groups, benzene, naphthalene, indane, tetralin, and fluorene.

Substituted hydrocarbyl, alkyl, aryl, cycloalkyl, alkoxy, etc. refer to the specific substituent wherein up to three H atoms in each residue are replaced with alkyl, halogen, haloalkyl, hydroxy, alkoxy, carboxy, carboalkoxy (also referred to as alkoxycarbonyl), carboxamido (also referred to as alkylaminocarbonyl), cyano, carbonyl, nitro, amino, alkylamino, dialkylamino, mercapto, alkylthio, sulfoxide, sulfone, acylamino, amidino, phenyl, benzyl, halobenzyl, heteroaryl, phenoxy, benzyloxy, heteroaryloxy, benzoyl, halobenzoyl, or lower alkylhydroxy.

The term “halogen” means fluorine, chlorine, bromine or iodine.

The term “polymer,” “polymeric material,” or “polymeric composition” as used throughout the description and claims of the application refers to any combination of monomer units but explicitly excludes polycarbonate and polychloroprene latex compositions.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

As used herein and in the appended claims, singular forms include plural referents unless the context clearly dictates otherwise. For example, the terms “a” and “an” and “the” as used herein do not denote a limitation of quantity and are to be construed to cover both the singular and the plural, unless otherwise indicated herein or clearly contradicted by context.

For purposes of describing the present invention, where an element, component, or feature is said to be included in and/or selected from a list of recited elements, components, or features, those skilled in the art will appreciate that in the related embodiments of the invention described herein, the element, component, or feature can also be any one of the individual recited elements, components, or features, or can also be selected from a group including any two or more of the explicitly listed elements, components, or features. Additionally, any element, component, or feature recited in such a list may also be omitted from such list. Any optional component of the polymer compositions, stabilized polymeric articles, or methods of reducing discoloration can be expressly excluded.

“At least one of” as used herein in connection with a list means that the list is inclusive of each element individually, as well as combinations of two or more elements of the list, and combinations of at least one element of the list with like elements not named.

Those skilled in the art will further understand that any recitation herein of a numerical range by endpoints includes all numbers subsumed within the recited range (including fractions), whether explicitly recited or not, as well as the endpoints of the range and equivalents. Thus, description of (1 to 5, for example, includes 1, 2, 3, 4, and 5 when referring to, for example, a number of elements, and can also include 1.5, 2, 2.75, and 3.8 when referring to, for example, measurements). Disclosure of a narrower range or more specific group in addition to a broader range or larger group is not a disclaimer of the broader range or larger group.

The invention may be embodied in many different forms and should not be construed as limited to the embodiments set forth herein. Rather, these embodiments are provided so that this disclosure will satisfy applicable legal requirements.

Those skilled in the art will appreciate that while preferred embodiments are discussed in more detail below, multiple embodiments of the polymer compositions, stabilized polymeric articles, and methods of reducing discoloration are contemplated as being within the scope of the invention. Thus, it should be noted that any feature described with respect to one aspect or one embodiment of the invention is interchangeable with another aspect or embodiment of the invention unless otherwise stated. It will be understood by those skilled in the art that any description of the invention, even though described in relation to a specific embodiment or drawing, is applicable to and interchangeable with other embodiments of the invention.

Accordingly, in one aspect, a polymer composition for making a stabilized polymeric article that is resistant to discoloration upon exposure to UV-C (190-280 nm) light includes: (i) an organic polymeric material; and (ii) a hindered phenol, organic phosphite, or a combination thereof, with the provisos that: (a) the OH group on the aromatic ring of the hindered phenol is flanked by two tertiary hydrocarbyl groups, and (b) the organic phosphite does not have any —OAr group linked directly to the P atom of the phosphite, wherein Ar represents an unsubstituted or substituted aryl group. In any or all embodiments of the polymer composition, reduced discoloration is associated with the use of specific hindered phenols and the organic phosphites compared to other hindered phenols and organic phosphites, even in the absence of other polymer additives including UV absorbers, hindered amine light stabilizers (HALS), metal oxides and/or barium salts.

The reduced discoloration is measured by comparing delta E and/or delta Yellow Index (YI) after 72 or more hours of exposure to UV-C light with an average irradiance of 1200 μW/cm² at 254 nm as illustrated in present Ex. 2 and 3. Delta E is measured according to ASTM D2244-16 and delta YI is measured according to ASTM E313-20. For determination of reduced discoloration, the hindered phenol or organic phosphite is compared to a comparative hindered phenol or organic phosphite at the same concentration in the range of 0.001 to 5.0% by weight of the total weight of the polymer composition in the same polymeric organic material.

The comparative hindered phenol can be (1,3,5-tris(4-tert-butyl-3-hydroxy-2,6-dimethylbenzyl)-1,3,5-triazine-2,4,6-(1H,3H,5H)-trione (CYANOX™ 1790). The comparative organic phosphite can be tris(2,4-di-tert-butylphenyl) phosphite (IRGAFOS™ 168), bis(2,4-di-tert-butylphenol) pentaerythritol diphosphite (WESTON™ 626), or bis(2,4-dicumylphenyl) pentaerythritol diphosphite (DOVERPHOS™ 9228). In any or all embodiments, the comparative hindered phenol is (1,3,5-tris(4-tert-butyl-3-hydroxy-2,6-dimethylbenzyl)-1,3,5-triazine-2,4,6-(1H,3H,5H)-trione (CYANOX™ 1790) and the comparative organic phosphite is tris(2,4-di-tert-butylphenyl) phosphite (IRGAFOS™ 168).

The organic polymeric material can be any polymeric organic material subject to discoloration upon exposure to UV-C (190-280 nm) light. For example, the polymeric organic polymeric material can be at least one of polyolefins, thermoplastic olefins (TPO), poly(ethylene-vinyl acetate) (EVA), polyesters, polyethers, polyketones, polyamides, natural and synthetic rubbers, polyurethanes, polystyrenes, polyacrylates, polymethacrylates, polybutyl acrylates, polyacetals, polyacrylonitriles, polybutadienes, acrylonitrile-butadiene-styrene (ABS), styrene-acrylonitrile (SAN), acrylonitrile-styrene-acrylate (ASA), cellulosic acetate butyrate, cellulosic polymers, polyimides, polyamideimides, polyetherimides, polyphenylene sulfides, polyphenylene oxides, polysulfones, polyethersulfones, polyvinyl chlorides, amino resin cross-linked polyacrylates and polyesters, polyisocyanate cross-linked polyesters and polyacrylates, phenol/formaldehyde, urea/formaldehyde and melamine/formaldehyde resins, alkyd resins, polyester resins, acrylate resins cross-linked with melamine resins, urea resins, isocyanates, isocyanurates, carbamates, or epoxy resins, cross-linked epoxy resins derived from aliphatic, cycloaliphatic, heterocyclic, and aromatic glycidyl ethers, which are cross-linked with anhydrides or amines, polysiloxanes, Michael addition polymers, addition polymers of amines or blocked amines with activated unsaturated and activated methylene compounds, addition polymers of ketimines with activated unsaturated and activated methylene compounds, polyketimines in combination with unsaturated acrylic polyacetoacetate resins, coating compositions, radiation curable compositions, epoxy melamine resins, organic dyes, cosmetics, cellulose based paper, photographic film paper, fibers, waxes, or inks.

In any or all embodiments, the organic polymeric material is a polyolefin. The polyolefin can be at least one of (i) polyethylene, polypropylene, polyisobutylene, polybut-1-ene, or poly-4-methylpent-1-ene; (ii) polyisoprene or polybutadiene; (iii) cyclopentene or norbornene; (iv) optionally crosslinked polyethylene, high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), very low density polyethylene (VLDPE), or ultralow density polyethylene (ULDPE); (v) thermoplastic olefins (TPO); or (vi) copolymers of at least one of mono-, di-, or cyclo-olefins.

In any or all embodiments, the amount of hindered phenol, organic phosphite, or combination thereof is from 0.001 to 5.0% by weight of the total weight of the polymer composition, preferably from 0.005 to 3.0% by weight of the total weight of the polymer composition, and more preferably from 0.01 to 1.0% by weight of the total weight of the polymer composition.

As discussed herein, hindered phenols in which the OH group of the aromatic ring is flanked by two tertiary hydrocarbyl groups are themselves more resistant to unfavorable discoloration than other hindered phenols, and are effective in protecting organic polymeric materials against the adverse effects of UV-C radiation. Accordingly, in any or all embodiments the hindered phenol can have at least one group according to Formulae (IVa), (IVb), or (IVc):

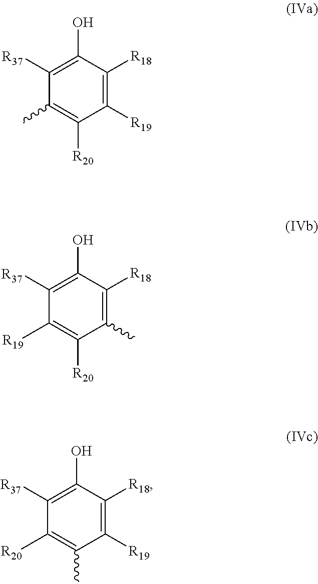

wherein: “ [symbol] ” indicates the point of attachment (via a carbon-carbon single bond) of the molecular fragment to a parent compound; R₁₈ and R₃₇ in Formulae (IVa), (IVb), or (IVc) are each independently a C₄₋₁₂ tertiary hydrocarbyl; and R₁₉ and R₂₀ in Formulae (IVa), (IVb), or (IVc) are each independently hydrogen or C₁-C₂₀ hydrocarbyl. In any or all embodiments, R₁₈ and R₃₇ of Formulae (IVa), (IVb), and (IVc) are each independently tert-butyl, 1,1-dimethylethyl, 1-methylcyclohexyl, or α,α-dimethylbenzyl.

The hindered phenols described herein are distinguished from the hindered benzoates according to Formula (VI) in that the hindered phenols lack a functional group R²³-T-C(═O)— para to the phenolic OH, i.e., neither R₂₀ in (IVa) and (IVb) supra, or the molecular fragment “ [symbol] ” in (IVc) supra, are R²³-T-C(═O)—, wherein T is O or NR²⁴, wherein R²⁴ is H or a C₁-C₃₀ hydrocarbyl; and R²³ is H or a C₁-C₃₀ hydrocarbyl, as required by the hindered benzoate of Formula (VI).

The hindered phenol can have a variety of R₁₉ and R₂₀ groups and parent compounds, provided that R₁₈ and R₃₇ of Formulae (IVa), (IVb), and (IVc) are each independently tert-butyl, 1,1-dimethylethyl, 1-methylcyclohexyl, or α,α-dimethylbenzyl. For example, the hindered phenol can be an alkylated monophenol, alkylated hydroquinone, alkylidenebisphenol, an O-, N-, S-, or P-benzyl compound, an ester of β-(3,5-di-tert-butyl-4-hydroxyphenyl)-propionic acid with monohydric or polyhydric alcohols, an amide of β-(3,5-di-tert-butyl-4-hydroxyphenyl)propionic acid, or other chemical classes.

In any or all embodiments, the hindered phenol can be an alkylated monophenol, for example at least one of 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, or 2,6-di-tert-butyl-4-methoxymethylphenol; an alkylated hydroquinone, for example 2,6-di-tert-butyl-4-methoxyphenol; or an alkylidenebisphenol, for example 4,4′-methylenebis-(2,6-di-tert-butylphenol).

In any or all embodiments, the hindered phenol can be an O-, N-, S-, or P-benzyl compound, for example at least one of 1,3,5-tris-(3,5-di-tert-butyl-4-hydroxybenzyl)isocyanurate, 1,3,5-tris-(3,5-di-tert-butyl-4-hydroxybenzyl)-2,4,6-trimethylbenzene, bis(3,5-di-tert-butyl-4-hydroxybenzyl)sulfide, isooctyl 3,5-di-tert-butyl-4-hydroxybenzylmercaptoacetate, bis(4-tert-butyl-3-hydroxy-2,6-dimethylbenzyl) dithiol terephthalate, dioctadecyl 3,5-di-tert-butyl-4-hydroxybenzylphosphonate, or the calcium salt of monoethyl 3,5-di-tert-butyl-4-hydroxybenzylphosphonate.

In any or all embodiments, the hindered phenol can be an ester of β-(3,5-di-tert-butyl-4-hydroxyphenyl)propionic acid with a monohydric or polyhydric alcohol. The monohydric or polyhydric alcohol can be for example at least one of methanol, octadecanol, 1,6-hexanediol, neopentyl glycol, thiodiethylene glycol, diethylene glycol, triethylene glycol, pentaerythritol, tris(hydroxyethyl)isocyanurate, or N,N′-bis(hydroxyethyl)oxamide.

In any or all embodiments, the hindered phenol can be an amide of β-(3,5-di-tert-butyl-4-hydroxyphenyl)propionic acid, for example at least one of N,N′-bis-(3,5-di-tert-butyl-4-hydroxyphenyl)propionyl)hexamethylenediamine, N,N′-bis(3,5-di-tert-butyl-4-hydroxyphenylpropionyl)trimethylenediamine, or N,N′-bis(3,5-di-tert-butyl-4-hydroxyphenylpropionyl)hydrazine.

In any or all embodiments, the hindered phenol can also be at least one of 2,4-bis-(octylmercapto)-6-(3,5-di-tert-butyl-4-hydroxyanilino)-s-triazine or octyl N-(3,5-di-tert-butyl-4-hydroxyphenyl)carbamate.

Without distinguishing between the different chemical classes summarized above, the hindered phenol can be at least one of:
3,5-di-tert-butyl-4-hydroxyanisole,
3,5-di-tert-butyl-4-hydroxyphenyl stearate,
bis(3,5-di-tert-butyl-4-hydroxyphenyl) adipate,
4,4′-methylenebis (2,6-di-tert-butylphenol),
2,2-bis(3,5-di-tert-butyl-4-hydroxyphenyl)propane,
3,5,3′,5′-tetra-tert-butyl-4,4′-dihydroxydibenzyl ether,
tris(3,5-di-tert-butyl-4-hydroxybenzyl)amine,
bis(3,5-di-tert-butyl-4-hydroxybenzyl) sulfide,
isooctyl 3,5-di-tert-butyl 4-hydroxybenzylmercaptoacetate,
didodecylmercaptoethyl 2,2-bis(3,5-di-tert-butyl-4-hydroxybenzyl)malonate,
di-[4-(1,1,3,3-tetramethylbutyl)phenyl]-2,2-bis(3,5-di-tert-butyl-4-hydroxybenzyl)malonate,
1,3,5-tris(3,5-di-tert-butyl-4-hydroxybenzyl)-2,4,6-trimethylbenzene,
1,4-bis(3,5-di-tert-butyl-4-hydroxybenzyl)-2,3,5,6-tetramethylbenzene,
2,4,6-tris-(3,5-di-tert-butyl-4-hydroxybenzyl)phenol,
2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine,
2-octylmercapto-4,6-bis (3,5-di-tert-butyl-4-hydroxyphenoxy)-1,3,5-triazine,
2,4,6-tris(3,5-di-tert-butyl-4-hydroxyphenoxy)-1,2,3-triazine,
1,3,5-tris(3,5-di-tert-butyl-4-hydroxybenzyl)isocyanurate,
2,4,6-tris(3,5-di-tert-butyl-4-hydroxyphenylethyl)-1,3,5-triazine,
1,3,5-tris(3,5-di-tert-butyl-4-hydroxyphenyl-propionyl)hexahydro-1,3,5-triazine,
amides of β-(3,5-di-tert-butyl-4-hydroxyphenyl)propionic acid,
N,N′-bis(3,5-di-tert-butyl-4-hydroxyphenylpropionyl)hexamethylenediamine,
N,N′-bis(3,5-di-tert-butyl-4-hydroxyphenylpropionyl)trimethylenediamine,
N,N′-bis(3,5-di-tert-butyl-4-hydroxyphenylpropionyl)hydrazine,
2,6-di-tert-butyl-N,N-dimethylamino-p-cresol,
4,4′-methylenebis(2,6-di-tert-butylphenol),
2,4-bis(n-octylthio)-6-(4-hydroxy-3,5-di-tert-butylanilino)-1,3,5-triazine,
1,6-hexanediyl 3,5-bis(1,1-dimethylethyl)-4-hydroxyphenylpropanoate,
octadecyl 3,5-di-tert-butyl-4-hydroxyhydrocinnamate,
tetrakis[methylene(3,5-di-tert-butyl-4-hydroxyhydrocinnamate)]methane,
esters of 3,5-di-tert-butyl-4-hydroxyphenylacetic acid,
thiodiethylenebis(3,5-di-tert-butyl-4-hydroxy)hydrocinnamate,
1,3,5-trimethyl-2,4,6-tris(3,5-di-tert-butyl-4-hydroxybenzyl)benzene, or
1,3,5-tris(3,5-di-tert-butyl-4-hydroxybenzyl)isocyanurate.

In any or all embodiments, the hindered phenol is at least one of pentaerythritol tetrakis(3-(3,5-di-tert-butyl-4-hydroxyphenyl)propionate) (IRGANOX™ 1010), octadecyl 3-(3,5-di-tert-butyl-4-hydroxyphenyl)propionate (IRGANOX™ 1076), 1,3,5-tris(3,5-di-tert-butyl-4-hydroxybenzyl)-1,3,5-triazine-2,4,6-(1H,3H,5H)-trione (IRGANOX™ 3114), or N,N′-bis(3,5-di-butyl-4-hydroxylphenyl propionyl)hydrazine (IRGANOX™ 1024).

As discussed herein, organic phosphites that do not have any —OAr group linked directly to the P atom of the phosphite, wherein Ar represents an unsubstituted or substituted aryl group, are themselves resistant to unfavorable discoloration and are effective in protecting organic polymeric materials against the adverse effects of UV-C radiation. Thus, in any or all embodiments, the organic phosphite is at least one of: P(OR₁₇)₃, wherein each R₁₇ is independently C₁-C₂₄ alkyl, C₃-C₂₀ cycloalkyl, or C₄-C₂₀ alkylcycloalkyl;

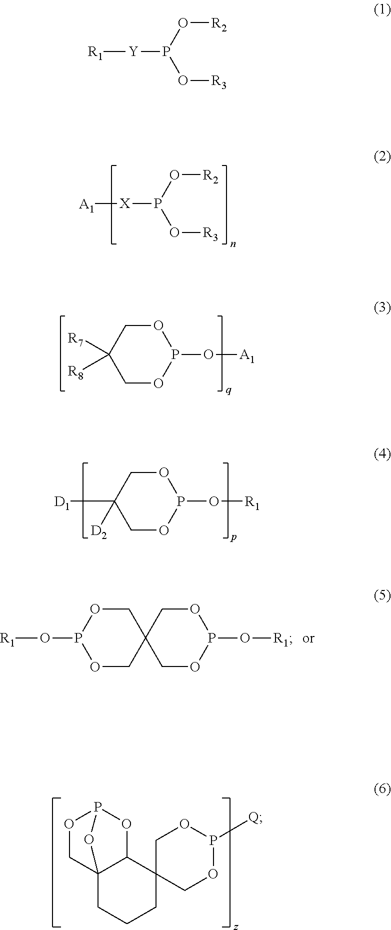

wherein:

the indices are integral and n is 2, 3 or 4; p is 1 or 2; q is 2 or 3; and z is 1 to 6;

X and Y are each oxygen;

A₁, if n or q is 2, is C₂-C₁₈ alkylene; C₂-C₁₂ alkylene interrupted by oxygen, sulfur or —NR₄—, or a divalent radical of the formula:

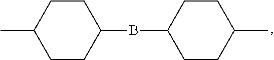

wherein B is a direct bond, —CH₂—, —CHR₄—, —CR₁R₄—, —S—, C₅-C₇ cycloalkylidene, or cyclohexylidene which is substituted by from 1 to 4 C₁-C₄ alkyl in position 3, 4 and/or 5;

A₁, if n or q is 3, is a trivalent carbon-centered radical of the formula CᵣH₂ᵣ₋₁, wherein r is an integer from 4 to 12;

A₁, if n is 4, is a tetravalent radical of the formula:

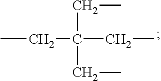

D₁, if p is 1, is C₁-C₄ alkyl and, if p is 2, is —CH₂OCH₂—;

D₂ is C₁-C₄ alkyl;

Q is the radical of an at least z-valent mono- or poly-alcohol, this radical being attached via the oxygen atom of the OH group of the mono- or poly-alcohol to the phosphorus atom;

R₁, R₂ and R₃ are each independently C₁-C₂₄ alkyl which is unsubstituted or substituted by halogen, —COOR₄, —CN or —CONR₄R₄, C₂-C₁₈ alkyl interrupted by oxygen, sulfur or —NR₄—, or C₅-C₁₂ cycloalkyl;

each R₄ is independently hydrogen, C₁-C₈ alkyl, or C₅-C₁₂ cycloalkyl;

R₇ and R₈, if q is 2, are each independently C₁-C₄ alkyl or together are a 2,3-dehydropentamethylene radical; and

R₇ and R₈, if q is 3, are methyl.

The organic phosphite can be, for example, at least one of trilauryl phosphite, trioctadecyl phosphite, tristearyl sorbityl triphosphite, or

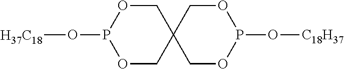

(distearyl pentaerythrityl diphosphite)

In any or all embodiments, the polymer composition further comprises 0.001 to 10 wt. %, preferably 0.01 to 5 wt. %, and more preferably from 0.02 to 2.5 wt. %, based on the weight of the organic polymer, of a stabilizer other than the hindered phenol or organic phosphite. The stabilizer can be at least one of a hindered amine light stabilizer (HALS), hindered benzoate, UV absorber (UVA), thiosynergist, nickel phenolate, hydroxylamine, benzofuranone, nitrone, or inorganic UV screener. Since these stabilizers are optional, they can be expressly excluded in any embodiment.

In any or all embodiments, the polymer composition can further include (as an optional component) a hindered amine light stabilizer (HALS) having at least one group according to Formula (II):

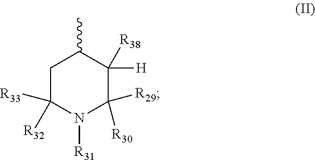

wherein:

R₃₁ is hydrogen, OH, C₁-C₂₀ hydrocarbyl, —CH₂CN, C₁-C₁₂ acyl, or C₁-C₁₈ alkoxy;

R₃₈ is hydrogen or C₁-C₈ hydrocarbyl; and

R₂₉, R₃₀, R₃₂, and R₃₃ are each independently C₁-C₂₀ hydrocarbyl, or R₂₉ and R₃₀ and/or R₃₂ and R₃₃ taken together with the carbon to which they are attached form a C₅-C₁₀ cycloalkyl; or

a group according to Formula (IIa):

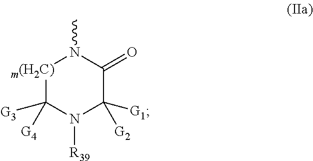

wherein:

m is an integer from 1 to 2;

R₃₉ is hydrogen, OH, C₁-C₂₀ hydrocarbyl, —CH₂CN, C₁-C₁₂ acyl, or C₁-C₁₈ alkoxy; and

G₁-G₄ are each independently C₁-C₂₀ hydrocarbyl.

In any or all embodiments, the hindered amine light stabilizer (HALS) can be, for example, at least one of bis(2,2,6,6-tetramethylpiperidin-4-yl) sebacate (TINUVIN™ 770); bis(2,2,6,6-tetramethylpiperidin-4-yl)succinate; bis(1,2,2,6,6-pentamethylpiperidin-4-yl)sebacate; bis(1-octyloxy-2,2,6,6-tetramethylpiperidin-4-yl)sebacate (TINUVIN™ 123); bis(1,2,2,6,6-pentamethylpiperidin-4-yl)n-butyl 3,5-di-tert-butyl-4-hydroxybenzylmalonate; a condensate of 1-(2-hydroxyethyl)-2,2,6,6-tetramethyl-4-hydroxypiperidine and succinic acid; 2,2,6,6-tetramethylpiperidin-4-yl stearate; 2,2,6,6-tetramethylpiperidin-4-yl dodecanoate; 1,2,2,6,6-pentamethylpiperidin-4-yl stearate; 1,2,2,6,6-pentamethylpiperidin-4-yl dodecanoate; a condensate of N,N′-bis(2,2,6,6-tetramethylpiperidin-4-yl)hexamethylenediamine and 4-tert-octylamino-2,6-dichloro-1,3,5-triazine; tris(2,2,6,6-tetramethylpiperidin-4-yl) nitrilotriacetate; 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl)malonate; 3-n-octyl-7,7,9,9-tetramethyl-1,3,8-triazaspiro[4.5]decan-2,4-dione; bis(1-octyloxy-2,2,6,6-tetramethylpiperidyl)sebacate; bis(1-octyloxy-2,2,6,6-tetramethylpiperidyl)succinate; a condensate of N,N′-bis(2,2,6,6-tetramethylpiperidin-4-yl)hexamethylenediamine and 4-morpholino-2,6-dichloro-1,3,5-triazine; a condensate of N,N′-bis(2,2,6,6-tetramethylpiperidin-4-yl)hexamethylenediamine and 4-morpholino-2,6-dichloro-1,3,5-triazine, methylated; a condensate of 2-chloro-4,6-bis(4-n-butylamino-2,2,6,6-tetramethylpiperidyl)-1,3,5-triazine and 1,2-bis(3-aminopropylamino)ethane; a condensate of 2-chloro-4,6-bis(4-n-butylamino-1,2,2,6,6-pentamethylpiperidyl)-1,3,5-triazine and 1,2-bis-(3-aminopropylamino)ethane; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl)pyrrolidin-2,5-dione; 3-dodecyl-1-(1-ethanoyl-2,2,6,6-tetramethylpiperidin-4-yl)pyrrolidin-2,5-dione; 3-dodecyl-1-(1,2,2,6,6-pentamethylpiperidin-4-yl)pyrrolidine-2,5-dione; a mixture of 4-hexadecyloxy- and 4-stearyloxy-2,2,6,6-tetramethylpiperidine, a mixture of 4-hexadecyloxy- and 4-stearyloxy-1,2,2,6,6-pentamethylpiperidine; a condensate of N,N′-bis(2,2,6,6-tetramethylpiperidin-4-yl)hexamethylenediamine and 4-cyclohexylamino-2,6-dichloro-1,3,5-triazine; a condensate of 1,2-bis(3-aminopropylamino)ethane, 2,4,6-trichloro-1,3,5-triazine and 4-butylamino-2,2,6,6-tetramethylpiperidine; 2-undecyl-7,7,9,9-tetramethyl-1-oxa-3,8-diaza-4-oxospiro[4.5]decane; oxo-piperazinyl-triazines; a reaction product of 7,7,9,9-tetramethyl-2-cycloundecyl-1-oxa-3,8-diaza-4-oxospiro[4.5]decane and epichlorohydrin; 1,2,3,4-butanetetracarboxylic acid, 2,2,6,6-tetramethyl-4-piperidinyl tridecyl ester; 1,2,3,4-butanetetracarboxylic acid, 1,2,2,6,6-pentamethyl-4-piperidinyl tridecyl ester; tetrakis(2,2,6,6-tetramethylpiperidin-4-yl)-1,2,3,4-butanetetracarboxylate; tetrakis(1,2,2,6,6-pentamethylpiperidin-4-yl)-1,2,3,4-butanetetracarboxylate; 1,2,3,4-butanetetracarboxylic acid, polymer with β,β,β′,β′-tetramethyl-2,4,8,10-tetraoxaspiro[5.5]-undecane-3,9-diethanol, 2,2,6,6-tetramethylpiperidin-4-yl ester; 1,2,3,4-butanetetracarboxylic acid, polymer with β,β,β′,β′-tetramethyl-2,4,8,10-tetraoxaspiro[5.5]-undecane-3,9-diethanol,1,2,2,6,6-pentamethylpiperidin-4-yl ester; bis(1-undecanoxy-2,2,6,6-tetramethylpiperidin-4-yl)carbonate; 1-(2-hydroxy-2-methylpropoxy)-2,2,6,6-tetramethyl-4-piperidinol; 1-(2-hydroxy-2-methylpropoxy)-4-octadecanoyloxy-2,2,6,6-tetramethylpiperidine; 1-(4-octadecanoyloxy-2,2,6,6-tetramethylpiperidin-1-yloxy)-2-octadecanoyloxy-2-methylpropane; 1-(2-hydroxyethyl)-2,2,6,6-tetramethyl-4-piperidinol; a reaction product of 1-(2-hydroxyethyl)-2,2,6,6-tetramethyl-4-piperidinol and dimethyl succinate; 2,2,4,4-tetramethyl-7-oxa-3,20-diazadispiro[5.1.11.2]heneicosen-21-one; esters of 2,2,6,6-tetramethyl-4-piperidinol with higher fatty acids; 3-dodecyl-1-(2,2,6,6-tetramethyl-4-piperidyl)pyrrolidine-2,5-dione; 1H-Pyrrole-2,5-dione, 1-octadecyl-, polymer with (1-methylethenyl)benzene and 1-(2,2,6,6-tetramethyl-4-piperidinyl)-1H-pyrrole-2,5-dione; 1,1′,1″-[1,3,5-triazine-2,4,6-triyl-tris[(cyclohexylimino)-2,1-ethanediyl]]tris[3,3,5,5-tetramethylpiperazin-2-one]; 1,1′,1″-[1,3,5-triazine-2,4,6-triyl-tris[(cyclohexylimino)-2,1-ethanediyl]]tris[3,3,4,5,5-pentamethylpiperazin-2-one]; the reaction product of 7,7,9,9-tetramethyl-2-cycloundecyl-1-oxa-3,8-diaza-4-oxospiro[4.5]decane and epichlorohydrin; the condensate of N,N′-bis(2,2,6,6-tetramethylpiperidin-4-yl)hexamethylenediamine and 4-cyclohexylamino-2,6-dichloro-1,3,5-triazine; the condensate of 1,2-bis(3-aminopropylamino)ethane, 2,4,6-trichloro-1,3,5-triazine and 4-butylamino-2,2,6,6-tetramethylpiperidine; the condensate of N,N′-bis(2,2,6,6-tetramethylpiperidin-4-yl)hexamethylenediamine and 4-morpholino-2,6-dichloro-1,3,5-triazine; the condensate of 2-chloro-4,6-bis(4-n-butylamino-2,2,6,6-tetramethylpiperidyl)-1,3,5-triazine and 1,2-bis(3-aminopropylamino)ethane; the condensate of 2-chloro-4,6-bis(4-n-butylamino-1,2,2,6,6-pentamethylpiperidyl)-1,3,5-triazine and 1,2-bis-(3-aminopropylamino)ethane; 2-[(2-hydroxyethyl)amino]-4,6-bis[N-(1-cyclohexyloxy-2,2,6,6-tetramethylpiperidin-4-yl)butylamino-1,3,5-triazine; propanedioic acid, [(4-methoxyphenyl)-methylene]-bis-(1,2,2,6,6-pentamethyl-4-piperidinyl) ester; benzenepropanoic acid, 3,5-bis(1,1-dimethylethyl)-4-hydroxy-, 1-[2-[3-[3,5-bis(1,1-dimethylethyl)-4-hydroxyphenyl]-1-oxopropoxy]ethyl]-2,2,6,6-tetramethyl-4-piperidinyl ester, N-(1-octyloxy-2,2,6,6-tetramethylpiperidin-4-yl)-N′-dodecyl-oxalamide; tris(2,2,6,6-tetramethylpiperidin-4-yl) nitrilotriacetate; 1,5-dioxaspiro{5,5}undecane-3,3-dicarboxylic acid, bis(1,2,2,6,6-pentamethyl-4-piperidinyl); 1,5-dioxaspiro{5,5}undecane-3,3-dicarboxylic acid, bis(2,2,6,6-tetramethyl-4-piperidinyl); the condensate of 1-(2-hydroxyethyl)-2,2,6,6-tetramethyl-4-hydroxypiperidine and succinic acid; the condensate of N,N′-bis(2,2,6,6-tetramethylpiperidin-4-yl)hexamethylenediamine and 4-tert-octylamino-2,6-dichloro-1,3,5-triazine; a mixture of 2,2,4,4-tetramethyl-21-oxo-7-oxa-3.20-diazaspiro(5.1.11.2)-heneicosane-20-propanoic acid-dodecyl ester and 2,2,4,4-tetramethyl-21-oxo-7-oxa-3.20-diazaspiro(5.1.11.2)-heneicosane-20-propanoic acid-tetradecyl ester; 1H,4H,5H,8H-2,3a,4a,6,7a,8a-hexaazacyclopenta[def]fluorene-4,8-dione, hexahydro-2,6-bis(2,2,6,6-tetramethyl-4-piperidinyl); polymethyl[propyl-3-oxy(2′,2′,6′,6′-tetramethyl-4,4′-piperidinyl)]siloxane; polymethyl[propyl-3-oxy(1′,2′,2′,6′,6′-pentamethyl-4,4′-piperidinyl)]siloxane; copolymer of methyl methacrylate with ethyl acrylate and 2,2,6,6-tetramethylpiperidin-4-yl acrylate; copolymer of mixed C₂₀ to C₂₄ alpha-olefins and (2,2,6,6-tetramethylpiperidin-4-yl)succinimide; 1,3-benzenedicarboxamide, N,N′-bis(2,2,6,6-tetramethyl-4-piperidinyl); 1,1′-1,10-dioxo-1,10-decanediyl)-bis(hexahydro-2,2,4,4,6-pentamethylpyrimidine; ethane diamide, N-(1-acetyl-2,2,6,6-tetramethylpiperidinyl)-N′-dodecyl; formamide, N,N′-1,6-hexanediylbis[N-(2,2,6,6-tetramethyl-4-piperidinyl) (UVINUL™ 4050); d-glucitol, 1,3:2,4-bis-O-(2,2,6,6-tetramethyl-4-piperidinylidene)-; 2,2,4,4-tetramethyl-7-oxa-3,20-diaza-21-oxo-dispiro[5.1.11.2]heneicosane; propanamide, 2-methyl-N-(2,2,6,6-tetramethyl-4-piperidinyl)-2-[(2,2,6,6-tetramethyl-4-piperidinyl)amino]-; 7-oxa-3,20-diazadispiro[5.1.11.2]heneicosane-20-propanoic acid, 2,2,4,4-tetramethyl-21-oxo-, dodecyl ester; N-(2,2,6,6-tetramethylpiperidin-4-yl)-β-aminopropionic acid dodecyl ester; N-(2,2,6,6-tetramethylpiperidin-4-yl)-N′-aminooxalamide; N-(2,2,6,6-tetramethyl-4-piperidinyl)-3-[(2,2,6,6-tetramethyl-4-piperidinyl)amino]-propanamide; 3-dodecyl-1-(1,2,2,6,6-pentamethylpiperidin-4-yl)pyrrolidine-2,5-dione, 3-dodecyl-1-(1-ethanoyl-2,2,6,6-pentamethylpiperidin-4-yl)pyrrolidine-2,5-dione; bis(2,2,6,6-tetramethylpiperidin-4-yl)succinate; bis(1,2,2,6,6-pentamethylpiperidin-4-yl)n-butyl 3,5-di-tert-butyl-4-hydroxybenzylmalonate; tris(2,2,6,6-tetramethylpiperidin-4-yl) nitrilotriacetate; 1,1′-(1,2-ethanediyl)bis(3,3,5,5-tetramethylpiperazin-2-one); 4-benzoyl-2,2,6,6-tetramethylpiperidine; 4-stearyloxy-2,2,6,6-tetramethylpiperidine; bis(1,2,2,6,6-pentamethylpiperidyl)-2-n-butyl-2-(2-hydroxy-3,5-di-tert-butylbenzyl)malonate; 3-n-octyl-7,7,9,9-tetramethyl-1,3,8-triazaspiro[4.5]decan-2,4-dione; bis(1-octyloxy-2,2,6,6-tetramethylpiperidyl)sebacate; bis(1-octyloxy-2,2,6,6-tetramethylpiperidyl)succinate; 8-acetyl-3-dodecyl-7,7,9,9-tetramethyl-1,3,8-triazaspiro[4.5]decane-2,4-dione; 3-dodecyl-1-(2,2,6,6-tetramethylpiperidin-4-yl)pyrrolidin-2,5-dione; 3-dodecyl-1-(1-ethanoyl-2,2,6,6-tetramethylpiperidin-4-yl)pyrrolidin-2,5-dione; 3-dodecyl-1-(1,2,2,6,6-pentamethylpiperidin-4-yl)pyrrolidine-2,5-dione; 2-undecyl-7,7,9,9-tetramethyl-1-oxa-3,8-diaza-4-oxospiro[4.5]decane; 1,5-dioxaspiro{5,5}undecane-3,3-dicarboxylic acid, bis(2,2,6,6-tetramethyl-4-piperidinyl) ester; 1,5-dioxaspiro{5,5}undecane-3,3-dicarboxylic acid, bis(1,2,2,6,6-pentamethyl-4-piperidinyl) ester; N¹-(β-hydroxyethyl)-3,3-pentamethylene-5,5-dimethylpiperazin-2-one; N¹-tert-octyl-3,3,5,5-tetramethyl-diazepin-2-one; N¹-tert-octyl-3,3-pentamethylene-5,5-hexamethylene-diazepin-2-one; N¹-tert-octyl-3,3-pentamethylene-5,5-dimethyl-piperazin-2-one; trans-1,2-cyclohexane-bis-(N¹-5,5-dimethyl-3,3-pentamethylene-piperazin-2-one); trans-1,2-cyclohexane-bis(N¹-3,3,5,5-dispiropentamethylene-piperazin-2-one); N¹-isopropyl-1,4-diazadispiro-3,3,5,5-pentamethylenepiperazin-2-one; N¹-isopropyl-1,4-diazadispiro-3,3-pentamethylene-5,5-tetramethylene-piperazin-2-one; N¹-isopropyl-5,5-dimethyl-3,3-pentamethylene-piperazin-2-one; trans-1,2-cyclohexane-bis-N¹-(dimethyl-3,3-pentamethylene-piperazin-2-one); N¹-octyl-5,5-dimethyl-3,3-pentamethylene-1,4-diazepin-2-one; N¹-octyl-1,4-diazadispiro-(3,3,5,5)pentamethylene-1,5-diazepin-2-one; a condensate of N,N′-bis(2,2,6,6-tetramethyl-1-(propyloxy)-piperidin-4-yl)hexamethylenediamine, 1-propyloxy-2,2,6,6-tetramethyl-4-n-butylaminopiperidine, di-n-butyl amine, and 2,4,6-trichloro-1,3,5-triazine (TINUVIN™ NOR HALS 371); or N,N′-bis(2,2,6,6-tetramethyl-4-piperidinyl)hexamethylenediamine, polymer with 2,4,6-trichloro-1,3,5-triazine, reaction products with 3-bromo-1-propene, di-n-butylamine, or 2,2,6,6-tetramethyl-4-n-butylpiperidine, oxidized, hydrogenated (TINUVIN™ XT 200).

In any or all embodiments, the hindered amine light stabilizer (HALS) is at least one of:
bis(2,2,6,6-tetramethylpiperidin-4-yl) sebacate (TINUVIN™ 770);
bis(2,2,6,6-tetramethylpiperidin-4-yl) succinate;
bis(1,2,2,6,6-pentamethylpiperidin-4-yl) sebacate;
bis(1-octyloxy-2,2,6,6-tetramethylpiperidin-4-yl) sebacate (TINUVIN™ 123);
bis(1-octyloxy-2,2,6,6-tetramethylpiperidyl) succinate;
bis(1,2,2,6,6-pentamethylpiperidin-4-yl)n-butyl 3,5-di-tert-butyl-4-hydroxybenzylmalonate;
a condensate of 1-(2-hydroxyethyl)-2,2,6,6-tetramethyl-4-hydroxypiperidine and succinic acid (TINUVIN™ 622);
2,2,6,6-tetramethylpiperidin-4-yl stearate;
2,2,6,6-tetramethylpiperidin-4-yl dodecanoate;
1,2,2,6,6-pentamethylpiperidin-4-yl stearate;
1,2,2,6,6-pentamethylpiperidin-4-yl dodecanoate;
a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);
tris(2,2,6,6-tetramethylpiperidin-4-yl) nitrilotriacetate;
4-stearyloxy-2,2,6,6-tetramethylpiperidine;
a condensate of N,N′-bis(2,2,6,6-tetramethylpiperidin-4-yl)hexamethylenediamine and 4-morpholino-2,6-dichloro-1,3,5-triazine (CYASORB™ UV-3346);
a condensate of N,N′-bis(2,2,6,6-tetramethylpiperidin-4-yl)hexamethylenediamine and 4-morpholino-2,6-dichloro-1,3,5-triazine, methylated (CYASORB™ UV-3529);
a condensate of 2-chloro-4,6-bis(4-n-butylamino-2,2,6,6-tetramethylpiperidyl)-1,3,5-triazine and 1,2-bis(3-aminopropylamino)ethane (CHIMASSORB™ 119);
a condensate of 2-chloro-4,6-bis(4-n-butylamino-1,2,2,6,6-pentamethylpiperidyl)-1,3,5-triazine and 1,2-bis-(3-aminopropylamino)ethane;
a condensate of N,N′-bis(2,2,6,6-tetramethylpiperidin-4-yl)hexamethylenediamine, 2,2,6,6-tetramethyl-4-n-butylaminopiperidine, di-n-butyl amine, and 2,4,6-trichloro-1,3,5-triazine (CHIMASSORB™ 2020);
a mixture of 4-hexadecyloxy- and 4-stearyloxy-2,2,6,6-tetramethylpiperidine;
a mixture of 4-hexadecyloxy- and 4-stearyloxy-1,2,2,6,6-pentamethylpiperidine;
a condensate of N,N′-bis(2,2,6,6-tetramethylpiperidin-4-yl)hexamethylenediamine and 4-cyclohexylamino-2,6-dichloro-1,3,5-triazine;
a condensate of 1,2-bis(3-aminopropylamino)ethane, 2,4,6-trichloro-1,3,5-triazine, and 4-n-butylamino-2,2,6,6-tetramethylpiperidine;
a condensate of N,N′-bis(2,2,6,6-tetramethylpiperidin-4-yl)hexamethylenediamine and 4-cyclohexylamino-2,6-dichloro-1,3,5-triazine;
tetrakis(2,2,6,6-tetramethylpiperidin-4-yl)-1,2,3,4-butanetetracarboxylate;
tetrakis(1,2,2,6,6-pentamethylpiperidin-4-yl)-1,2,3,4-butanetetracarboxylate;
1,2,3,4-butanetetracarboxylic acid, 2,2,6,6-tetramethylpiperidin-4-yl tridecyl ester;
1,2,3,4-butanetetracarboxylic acid, 1,2,2,6,6-pentamethylpiperidin-4-yl tridecyl ester;
N,N′-1,6-hexanediyl-bis[N-(2,2,6,6-tetramethylpiperidin-4-yl)formamide (UVINUL™ 4050);
a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);
a condensate of N,N′-bis(2,2,6,6-tetramethyl-1-(propyloxy)-piperidin-4-yl)hexamethylenediamine, 1-hydroxypropyl-2,2,6,6-tetramethyl-4-n-butylaminopiperidine, di-n-butyl amine, and 2,4,6-trichloro-1,3,5-triazine (TINUVIN™ NOR HALS 371); or
N,N′-bis(2,2,6,6-tetramethylpiperidin-4-yl)hexamethylenediamine, polymer with 2,4,6-trichloro-1,3,5-triazine, reaction products with 3-bromo-1-propene, di-n-butylamine, and 2,2,6,6-tetramethyl-4-n-butylpiperidine, oxidized, hydrogenated
(TINUVIN™ XT 200); TINUVIN™ XT-850/XT-855; or
N¹,N^{1′}-1,2-ethanediylbis(1,3-propanediamine), reaction products with cyclohexane and peroxidized N-butyl-2,2,6,6-tetramethyl-4-piperidinamine-2,4,6-trichloro-1,3,5-triazine (FLAMESTAB™ NOR 116).

In any or all embodiments, the polymer composition can further include (as an optional component) a UV absorber (UVA). The UVA can be at least one 2-(2′-hydroxyphenyl)-s-triazine, 2-hydroxybenzophenone, 2-(2′-hydroxyphenyl)benzotriazole, or benzoxazinone. For example, the polymer composition can further comprise a 2-(2′-hydroxyphenyl)-s-triazine. The 2-(2′-hydroxyphenyl)-s-triazine can be at least one compound according to Formula (I):

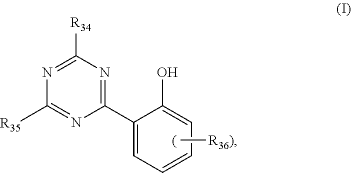

wherein each of R₃₄ and R₃₅ is independently chosen from a C₆-C₁₀ aryl group, mono- or di-C₁-C₁₂ hydrocarbyl-substituted amino, C₂-C₁₂ alkanoyl, C₁-C₁₂ alkyl, C₁-C₁₀ acyl, or C₁-C₁₀ alkoxyl,

wherein the C₆-C₁₀ aryl group is optionally substituted at from 1 to 3 substitutable positions with at least one of OH, halogen, C₁-C₁₂ alkyl, C₁-C₁₂ alkoxy, C₁₋₁₂ alkoxyester, C₂₋₁₂ alkanoyl, or phenyl, wherein the phenyl is optionally substituted at from 1 to 3 substitutable positions with at least one of OH, halogen, C₁₋₁₂ alkyl, C₁₋₁₂ alkoxy, C₁₋₁₂ alkoxyester, or C₂₋₁₂ alkanoyl; and

each R₃₆ is independently chosen from OH, halogen, C₁-C₁₂ alkyl, C₁-C₁₂ alkoxy, C₁-C₁₂ alkoxyester, C₂-C₁₂ alkanoyl, phenyl, or C₁-C₁₂ acyl.

In any or all embodiments, the 2-(2′-hydroxyphenyl)-s-triazine can be, for example, at least one of 4,6-bis-(2,4-dimethylphenyl)-2-(2-hydroxy-4-octyloxyphenyl)-s-triazine (CYASORB™ 1164); 4,6-bis-(2,4-dimethylphenyl)-2-(2,4-dihydroxyphenyl)-s-triazine; 2,4-bis(2,4-dihydroxyphenyl)-6-(4-chlorophenyl)-s-triazine; 2,4-bis[2-hydroxy-4-(2-hydroxy-ethoxy)phenyl]-6-(4-chlorophenyl)-s-triazine; 2,4-bis[2-hydroxy-4-(2-hydroxy-4-(2-hydroxy-ethoxy)phenyl]-6-(2,4-dimethylphenyl)-s-triazine; 2,4-bis[2-hydroxy-4-(2-hydroxyethoxy)phenyl]-6-(4-bromophenyl)-s-triazine; 2,4-bis[2-hydroxy-4-(2-acetoxyethoxy)phenyl]-6-(4-chlorophenyl)-s-triazine; 2,4-bis(2,4-dihydroxyphenyl)-6-(2,4-dimethylphenyl)-s-triazine; 2,4-bis(4-biphenylyl)-6-[2-hydroxy-4-[(octyloxycarbonyl)ethylideneoxy]phenyl]-s-triazine; 2,4-bis(4-biphenylyl)-6-[2-hydroxy-4-(2-ethylhexyloxy)phenyl]-s-triazine (TINUVIN™ 1600); 2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-triazine; 2,4-bis(2,4-dimethylphenyl)-6-[2-hydroxy-4(-3-benzyloxy-2-hydroxypropyloxy)phenyl]-s-triazine; 2,4-bis(2-hydroxy-4-n-butyloxyphenyl)-6-(2,4-di-n-butyloxyphenyl)-s-triazine; 2,4-bis(2,4-dimethylphenyl)-6-[2-hydroxy-4-(3-nonyloxy-2-hydroxypropyloxy)-5-α-cumylphenyl]-s-triazine; methylenebis(2,4-bis(2,4-dimethylphenyl)-6-[2-hydroxy-4-(3-butyloxy-2-hydroxypropoxy)phenyl]-s-triazine); mixture of methylene bridged dimers bridged in the 3:5′, 5:5′ and 3:3′ positions in a 5:4:1 ratio; 2,4,6-tris(2-hydroxy-4-isooctyloxycarbonyliso-propylideneoxy-phenyl)-s-triazine; 2,4-bis(2,4-dimethylphenyl)-6-(2-hydroxy-4-hexyloxy-5-α-cumylphenyl)-s-triazine; 2-(2,4,6-trimethylphenyl)-4,6-bis[2-hydroxy-4-(3-butyloxy-2-hydroxypropyloxy)phenyl]-s-triazine; 2,4,6-tris[2-hydroxy-4-(3-sec-butyloxy-2-hydroxypropyloxy)-phenyl]-s-triazine; mixture of 4,6-bis-(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine (TINUVIN™ 400); 4,6-bis(2,4-dimethylphenyl)-2-(2-hydroxy-4(3-(2-ethylhexyloxy)-2-hydroxypropoxy)phenyl)-s-triazine; or 4,6-diphenyl-2-(4-hexyloxy-2-hydroxyphenyl)-s-triazine (TINUVIN™ 1577).

In any or all embodiments, the 2-(2′-hydroxyphenyl)-s-triazine is at least one of:
4,6-bis-(2,4-dimethylphenyl)-2-(2-hydroxy-4-octyloxyphenyl)-s-triazine (CYASORB™ 1164),
2,4-bis[2-hydroxy-4-(2-hydroxy-4-(2-hydroxy-ethoxy)phenyl]-6-(2,4-dimethylphenyl)-s-triazine,
2,4-bis(4-biphenylyl)-6-[2-hydroxy-4-[(octyloxycarbonyl)ethylideneoxy]phenyl]-s-triazine,
2,4-bis(4-biphenylyl)-6-[2-hydroxy-4-(2-ethylhexyloxy)phenyl]-s-triazine (TINUVIN™ 1600),
2,4,6-tris[2-hydroxy-4-(3-sec-butyloxy-2-hydroxypropyloxy)-phenyl]-s-triazine,
mixture of 4,6-bis-(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine (TINUVIN™ 400),
4,6-bis-(2,4-dimethylphenyl)-2-(2-hydroxy-4(3-(2-ethylhexyloxy)-2-hydroxypropoxy)-phenyl)-s-triazine, or
4,6-diphenyl-2-(4-hexyloxy-2-hydroxyphenyl)-s-triazine (TINUVIN™ 1577).

In any or all embodiments, the UVA can be a 2-hydroxybenzophenone. 2-Hydroxybenzophenones are well known in the art. They are disclosed, for example, in U.S. Pat. Nos. 2,976,259, 3,049,443, and 3,399,169, which are incorporated herein by reference. The 2-hydroxybenzophenone can be, for example, at least one of 2-hydroxy-4-methoxybenzophenone (CYASORB™ UV-9), 2,2′-dihydroxy-4-methoxybenzophenone (CYASORB™ UV-24), 2-hydroxy-4-octyloxybenzophenone (CYASORB™ UV-24), 2,2′-dihydroxy-4,4′-di-methoxybenzophenone, 2,2′-dihydroxybenzophenone, 2,2′,4,4′-tetrahydroxybenzophenone, 2,2′-dihydroxy-4,4′-dimethoxybenzophenone, 2,2′-dihydroxy-4,4′-diethoxybenzophenone, 2,2′-dihydroxy-4,4′-dipropoxybenzophenone, 2,2′-dihydroxy-4,4′-dibutoxybenzophenone, 2,2′-dihydroxy-4-methoxy-4′-ethoxybenzophenone, 2,2′-dihydroxy-4-methoxy-4′-propoxybenzophenone, 2,2′-dihydroxy-4-methoxy-4′-butoxybenzophenone, 2,2′-dihydroxy-4-ethoxy-4′-propoxybenzophenone, 2,2′-dihydroxy-4-ethoxy-4′-butoxybenzophenone, 2,3′-dihydroxy-4,4′-dimethoxybenzophenone, 2,3′-dihydroxy-4-methoxy-4′-butoxybenzophenone, 2-hydroxy-4,4′,5′-trimethoxybenzophenone, 2-hydroxy-4,4′,6′-tributoxybenzophenone, 2-hydroxy-4-butoxy-4′,5′-dimethoxybenzophenone, 2-hydroxy-4-ethoxy-2′,4′-dibutylbenzophenone, 2-hydroxy-4-propoxy-4′,6′-dichlorobenzophenone, 2-hydroxy-4-propoxy-4′,6′-dibromobenzophenone, 2,4-dihydroxybenzophenone, 2-hydroxy-4-ethoxybenzophenone, 2-hydroxy-4-propoxybenzophenone, 2-hydroxy-4-butoxybenzophenone, 2-hydroxy-4-methoxy-4′-methylbenzophenone, 2-hydroxy-4-methoxy-4′-ethylbenzophenone, 2-hydroxy-4-methoxy-4′-propylbenzophenone, 2-hydroxy-4-methoxy-4′-butylbenzophenone, 2-hydroxy-4-methoxy-4′-tert-butylbenzophenone, 2-hydroxy-4-methoxy-4′-chlorobenzophenone, 2-hydroxy-4-methoxy-2′-chlorobenzophenone, 2-hydroxy-4-methoxy-4′-bromobenzophenone, 2-hydroxy-4,4′-dimethoxybenzophenone, 2-hydroxy-4,4′-dimethoxy-3-methylbenzophenone, 2-hydroxy-4,4′-dimethoxy-2′-ethylbenzophenone, 2-hydroxy-4,4′,5′-trimethoxybenzophenone, 2-hydroxy-4-ethoxy-4′-methylbenzophenone, 2-hydroxy-4-ethoxy-4′-ethylbenzophenone, 2-hydroxy-4-ethoxy-4′-propylbenzophenone, 2-hydroxy-4-ethoxy-4′-butylbenzophenone, 2-hydroxy-4-ethoxy-4′-methoxybenzophenone, 2-hydroxy-4,4′-diethoxybenzophenone, 2-hydroxy-4-ethoxy-4′-propoxybenzophenone, 2-hydroxy-4-ethoxy-4′-butoxybenzophenone, 2-hydroxy-4-ethoxy-4′-chlorobenzophenone, or 2-hydroxy-4-ethoxy-4′-bromobenzophenone.

In any or all embodiments, the UVA can be a 2-(2′-hydroxyphenyl)benzotriazole. The 2-hydroxyphenyl benzotriazole can be, for example, at least one of 2-(2′-hydroxy-5′-methylphenyl)benzotriazole (TINUVIN™ P), 2-(2′-hydroxy-5′-tert-butylphenyl)benzotriazole, 2-(2′-hydroxy-3′-methyl-5′-tert-butylphenyl)benzotriazole, 2-(2′-hydroxy-5′-cyclohexylphenyl)benzotriazole, 2-(2′-hydroxy-3′,5′-dimethylphenyl)benzotriazole, 2-(2′-hydroxy-5′-tert-butylphenyl)-5-chloro-benzotriazole, 2-(2′-hydroxy-5′-tert-octylphenyl)benzotriazole (CYASORB™ UV-5411), 2-(3′,5′-di-tert-butyl-2′-hydroxyphenyl)-5-chlorobenzotriazole, 2-(3′,5′-di-tert-amyl-2′-hydroxyphenyl)benzotriazole (CYASORB™ UV-2337), 2-(3′,5′-bis(α,α-dimethylbenzyl)-2′-hydroxyphenyl)benzotriazole (TINUVIN™ 900), 2-(3′-tert-butyl-2′-hydroxy-5′-(2-octyloxycarbonylethyl)phenyl)benzotriazole, 2,2′-methylenebis[4-(1,1,3,3-tetramethylbutyl)-6-benzotriazole-2-ylphenol], the transesterification product of 2-[3′-tert-butyl-5′-(2-methoxycarbonylethyl)-2′-hydroxyphenyl]-2H-benzotriazole with polyethylene glycol 300 (TINUVIN™ 1130), 2-[2′-hydroxy-3′-(α,α-dimethylbenzyl)-5′-(1,1,3,3-tetramethylbutyl)phenyl]benzotriazole, 5-trifluoromethyl-2-(2-hydroxy-3-α-cumyl-5-tert-octylphenyl)benzotriazole, 2-(2′-hydroxy-5′-(2-hydroxyethyl)phenyl)benzotriazole, 2-(2′-hydroxy-5′-(2-methacryloyloxyethyl)phenyl)benzotriazole, 2-(2′-hydroxy-3′-tert-butyl-5′-methylphenyl)-5-chlorobenzotriazole (TINUVIN™ 326), 2-(3′-sec-butyl-5′-tert-butyl-2′-hydroxyphenyl)benzotriazole, 2-(3′,5′-di-tert-butyl-2′-hydroxyphenyl)benzotriazole, 2-(3′-dodecyl-5′-methyl-2′-hydroxyphenyl)-benzotriazole, 2-(3′-tert-butyl-5′-(2-octyloxycarbonylethyl)-2′-hydroxyphenyl)-5-chlorobenzotriazole, 2-(5′-methyl-2′-hydroxyphenyl)benzotriazole, 2-(5′-tert-butyl-2′-hydroxyphenyl)benzotriazole, or 2-(2′-hydroxy-3′-di-tert-butylphenyl)benzotriazole.

In any or all embodiments, the UVA can be a benzoxazinone. Benzoxazinones are also well known in the art. They are disclosed, for example, in U.S. Pat. Nos. 4,446,262 and 6,774,232, which are incorporated herein by reference. The benzoxazinone can be, for example, at least one of 2-methyl-3,1-benzoxazin-4-one, 2-butyl-3,1-benzoxazin-4-one, 2-phenyl-3,1-benzoxazin-4-one, 2-(1- or 2-naphthyl)-3,1-benzoxazin-4-one, 2-(4-biphenyl)-3,1-benzoxazin-4-one, 2-p-nitrophenyl-3,1-benzoxazin-4-one, 2-m-nitrophenyl-3,1-benzoxazin-4-one, 2-p-benzoylphenyl-3,1-benzoxazin-4-one, 2-p-methoxyphenyl-3,1-benzoxazin-4-one, 2-O-methoxyphenyl-3,1-benzoxazin-4-one, 2-cyclohexyl-3,1-benzoxazin-4-one, 2-p-(or m-)phthalimidephenyl-3,1-benzoxazin-4-one, N-phenyl-4-(3,1-benzoxazin-4-one-2-yl)phthalimide, N-benzoyl-4-(3,1-benzoxazine-4-one-2-yl)aniline, N-benzoyl-N-methyl-4-(3,1-benzoxazin-4-one-2-yl)-aniline, 2-[p-(N-phenylcarbamonyl)phenyl]-3,1-benzoxazin-4-one, 2-[p-(N-phenyl N-methylcarbamoyl)phenyl]-3,1-benzoxazin-4-one, 2,2′-bis(3,1-benzoxazin-4-one), 2,2′-ethylenebis(3,1-benzoxazin-4-one), 2,2′-tetramethylenebis(3,1-benzoxazin-4-one), 2,2′-hexamethylenebis(3,1-benzoxazin-4-one), 2,2′-decamethylenebis(3,1-benzoxazin-4-one), 2,2′-p-phenylenebis(3,1-benzoxazin-4-one) (CYASORB™ UV-3638), 2,2′-m-phenylenebis(3,1-benzoxazin-4-one), 2,2′-(4,4′-diphenylene)bis(3,1-benzoxazin-4-one), 2,2′-(2,6- or 1,5-naphthalene)bis(3,1-benzoxazin-4-one), 2,2′-(2-methyl-p-phenylene)bis(3,1-benzoxazin-4-one), 2,2′-(2-nitro-p-phenylene)bis(3,1-benzoxazin-4-one), 2,2′-(2-chloro-p-phenylene)bis(3,1-benzoxazin-4-one), 2,2′-(1,4-cyclohexylene)bis(3,1-benzoxazin-4-one), N-p-(3,1-benzoxazin-4-on-2-yl)phenyl, 4-(3,1-benzoxazin-4-on-2-yl)phthalimide, N-p-(3,1-benzoxazin-4-on-2-yl)benzoyl, 4-(3,1-benzoxazin-4-on-2-yl)aniline, 1,3,5-tri(3,1-benzoxazin-4-on-2-yl)benzene, 1,3,5-tri(3,1-benzoxazin-4-on-2-yl)naphthalene, or 2,4,6-tri(3,1-benzoxazin-4-on-2-yl)naphthalene.

In any or all embodiments, the polymer composition can further include a hindered benzoate according to Formula (VI):

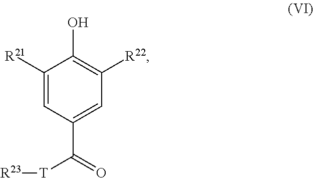

wherein:

each of R²¹ and R²² is independently a C₁-C₁₂ alkyl;

T is —O— or —NR²⁴—, wherein R²⁴ is H or a C₁-C₃₀ hydrocarbyl; and

R²³ is H or a C₁-C₃₀ hydrocarbyl.

The hindered benzoate can be, for example, at least one of 2,4-di-tert-butylphenyl-3,5-di-tert-butyl-4-hydroxybenzoate, hexadecyl-3,5-di-tert-butyl-4-hydroxybenzoate (CYASORB™ UV-2908), octadecyl-3,5-di-tert-butyl-4-hydroxybenzoate, octyl-3,5-di-tert-butyl-4-hydroxybenzoate, decyl-3,5-di-tert-butyl-4-hydroxybenzoate, dodecyl-3,5-di-tert-butyl-4-hydroxybenzoate, tetradecyl-3,5-di-tert-butyl-4-hydroxybenzoate, behenyl-3,5-di-tert-butyl-4-hydroxybenzoate, 2-methyl-4,6-di-tert-butylphenyl-3,5-di-tert-butyl-4-hydroxybenzoate, or butyl-3-[3-tert-butyl-4-(3,5-di-tert-butyl-4-hydroxybenzoyloxy)phenyl]propionate.

In any or all embodiments, the polymer composition can further include a thiosynergist. The thiosynergist can be an ester of 3,3′-thiodipropionic acid, an ester of 3-alkylthiopropionic acid, a thioether, or other organosulfur compound. The thiosynergist can be, for example, at least one of dilauryl 3,3′-thiodipropionate, dimyristyl 3,3′-thiodipropionate, ditridecyl 3,3′-thiodipropionate, distearyl 3,3′-thiodipropionate, pentaerythritol tetrakis-(3-dodecylthiopropionate), a tetraalkyl thioethyl thiodisuccinate, 2,12-dihydroxy-4,10-dithia-7-oxatridecamethylene bis[3-(dodecylthio)propionate], 2-mercaptobenzimidazole, 2-mercaptobenzimidazole, zinc salt, zinc dibutyldithiocarbamate, or dioctadecyl disulfide.

In any or all embodiments, the polymer composition can further include (as an optional component) an inorganic compound. Certain inorganic compounds are useful as UV screeners, pigments, or fillers. The inorganic compound can be, for example, at least one of titanium dioxide, barium sulfate, zinc oxide, or cerium(IV) oxide.

As those skilled in the art will appreciate, optional additives can be expressly excluded in any embodiment. For example, the polymer compositions can also be free of barium compounds. Barium compounds include, for example, barium salts such as barium sulfate. “Free of” means that the polymer compositions described herein have less than 1% by weight, less than 0.1% by weight, less than 0.01% by weight, or less than 0.001% by weight of a compound (such as a barium compound), based on the total weight of the polymer composition.

Surprisingly, reduced discoloration upon repeated or prolonged exposure to UV-C (190-280 nm) light, for example from a disinfectant (germicidal) light source, is associated with the use of specific hindered phenols and organic phosphites as defined herein compared to other hindered phenols and organic phosphites, even in the absence of other polymer additives including UV absorbers, hindered amine light stabilizers (HALS), metal oxides and/or barium salts. Thus, the polymer compositions described herein are advantageously used to reduce discoloration of organic polymer materials upon exposure to UV-C (190-280 nm) light compared to polymer compositions comprising other hindered phenols and organic phosphites. A method of reducing discoloration of an organic polymeric material upon exposure to UV-C (190-280 nm) light comprises adding a stabilizing amount of a hindered phenol, organic phosphite, or combination thereof as defined herein to an organic polymeric material, wherein reduced discoloration is associated with the use of specific hindered phenols and the organic phosphites compared to other hindered phenols and organic phosphites. Embodiments of the polymer composition likewise apply to the method of reducing discoloration of the organic polymeric material. Thus, in the method of reducing discoloration, (a) the OH group on the aromatic ring of the hindered phenol of the method is flanked by tertiary-hydrocarbyl groups, and (b) the organic phosphite of the method does not have any —OAr group linked directly to the P of the phosphite, wherein Ar represents an unsubstituted or substituted aryl group. The stabilizing amount of the hindered phenol, organic phosphite, or combination thereof as defined herein is from 0.001 to 5.0% by weight of the total weight of the polymer composition.

The hindered phenol, organic phosphite, or combination thereof as described herein, and optionally other additives, can be added to the polymeric organic material by any suitable method known to those of skill in the art, for example by direct mixing, dry mixing, melting, or by extruding, pelletizing, grinding, and molding. The additives can be added neat, i.e., in the absence of a solvent or polymeric carrier. The additives can also be added as a solution or dispersion in a solvent, optionally followed by evaporation of the solvent. The additives can also be added as a masterbatch, i.e., as a concentrate in a polymeric organic material. The additives in particulate form can also be encapsulated by waxes, oils, or polymers for addition to the polymeric organic material.

The polymer compositions described herein can be contained in a kit. The kit can have single or multiple components, each component selected from the group consisting of the organic polymeric material, the hindered phenol, the organic phosphite, other additives described herein, and combinations thereof. Thus, one or more components of a polymer composition can be in a first container, and one or more other components of the polymer composition can optionally be in a second or more containers. The containers can be packaged together, and the kit can include administration or mixing instructions on a label or on an insert included with the kit, optionally with a web address or bar code for further information. In addition to the components of the polymer composition, the kit can include additional functional parts or means for administering or mixing the components, including solvents.

The hindered phenol, organic phosphite, or combination thereof, and optionally other additives, can be added before or during formation of the organic polymeric material from monomers by polymerization or before crosslinking of the polymeric organic material. The additives can be premixed, or preblended before adding to the polymeric organic material. The additives in the form of melts, or solutions or dispersions in solvents, can also be sprayed onto the polymeric organic material.

The polymer compositions as defined herein can be utilized in industrial manufacturing processes to produce stabilized polymeric articles. Thus, methods of producing stabilized polymeric articles by adding a stabilizing amount of the hindered phenol, organic phosphite, or combination thereof to a polymeric organic material and shaping the polymer composition are also provided herewith. The shaping can be done, for example, by molding, extrusion, blowing, casting, thermoforming, compacting, or variations or combinations thereof. The molding can be, for example, injection molding, rotomolding, blow molding, reel-to-reel molding, metal injection molding, compression molding, transfer molding, dip molding, gas assist molding, insert injection molding, micro molding, reaction injection molding, two shot injection molding, or variations or combinations thereof.

The polymer compositions described herein are advantageously used to make stabilized polymeric articles that are more resistant to discoloration upon exposure to a UV-C (190-280 nm) light, for example from a disinfectant (germicidal) light source, compared to polymer compositions comprising other hindered phenols and organic phosphites. Thus, a stabilized polymeric article comprises the polymer composition described herein. Embodiments of the polymer composition likewise apply to the stabilized polymeric articles comprising the polymer composition. For example, the stabilized polymeric article comprises a polymer composition comprising: (i) an organic polymeric material; and (ii) a hindered phenol, an organic phosphite, or a combination thereof, with the provisos that: (a) the OH group on the aromatic ring of the hindered phenol is flanked by tertiary-hydrocarbyl groups, and (b) the organic phosphite does not have any —OAr group linked directly to the P of the phosphite, wherein Ar represents an unsubstituted or substituted aryl group. In any or all embodiments of the stabilized polymeric article, reduced discoloration is associated with the use of specific hindered phenols and the organic phosphites compared to other hindered phenols and organic phosphites, even in the absence of other polymer additives including UV absorbers, hindered amine light stabilizers (HALS), metal oxides and/or barium salts.

Similarly, a method of reducing discoloration of an organic polymeric material upon exposure to UV-C (190-280 nm) light includes adding to the organic polymeric material a stabilizing amount of a hindered phenol, an organic phosphite, or a combination thereof, with the provisos that: (a) the OH group on the aromatic ring of the hindered phenol is flanked by tertiary-hydrocarbyl groups, and (b) the organic phosphite does not have any —OAr group linked directly to the P of the phosphite, wherein Ar represents an unsubstituted or substituted aryl group. Advantageously, reduced discoloration is associated with the use of specific hindered phenols and the organic phosphites compared to other hindered phenols and organic phosphites, even in the absence of other polymer additives including UV absorbers, hindered amine light stabilizers (HALS), metal oxides and/or barium salts. The stabilizing amount of the hindered phenol, organic phosphite, or combination thereof can be from 0.001 to 5.0% by weight of the total weight of the polymer composition.

As described herein, the present disclosure includes at least the following embodiments:

A polymer composition for making a stabilized polymeric article that is resistant to discoloration upon exposure to UV-C (190-280 nm) light, the polymer composition comprising:
i) an organic polymeric material; and
ii) a hindered phenol, an organic phosphite, or a combination thereof, with the provisos that:
   a) the OH group on the aromatic ring of the hindered phenol is flanked by tertiary-hydrocarbyl groups, and
   b) the organic phosphite does not have any —OAr group linked directly to the P of the phosphite, wherein Ar represents an unsubstituted or substituted aryl group.

In the same (i.e., foregoing) or other embodiments of the polymer composition, reduced discoloration is associated with the use of specific hindered phenols and the organic phosphites compared to other hindered phenols and organic phosphites, even in the absence of other polymer additives including UV absorbers, hindered amine light stabilizers (HALS), metal oxides and/or barium salts.

In any of the same or other embodiments of the polymer composition, the organic polymeric material includes at least one of polyolefins, thermoplastic olefins (TPO), poly(ethylene-vinyl acetate) (EVA), polyesters, polyethers, polyketones, polyamides, natural and synthetic rubbers, polyurethanes, polystyrenes, polyacrylates, polymethacrylates, polybutyl acrylates, polyacetals, polyacrylonitriles, polybutadienes, acrylonitrile-butadiene-styrene (ABS), styrene-acrylonitrile (SAN), acrylonitrile-styrene-acrylate (ASA), cellulosic acetate butyrate, cellulosic polymers, polyimides, polyamideimides, polyetherimides, polyphenylene sulfides, polyphenylene oxides, polysulfones, polyethersulfones, polyvinyl chlorides, amino resin cross-linked polyacrylates and polyesters, polyisocyanate cross-linked polyesters and polyacrylates, phenol/formaldehyde, urea/formaldehyde and melamine/formaldehyde resins, alkyd resins, polyester resins, acrylate resins cross-linked with melamine resins, urea resins, isocyanates, isocyanurates, carbamates, or epoxy resins, cross-linked epoxy resins derived from aliphatic, cycloaliphatic, heterocyclic, and aromatic glycidyl ethers, which are cross-linked with anhydrides or amines, polysiloxanes, Michael addition polymers, addition polymers of amines or blocked amines with activated unsaturated and activated methylene compounds, addition polymers of ketimines with activated unsaturated and activated methylene compounds, polyketimines in combination with unsaturated acrylic polyacetoacetate resins, coating compositions, radiation curable compositions, epoxy melamine resins, organic dyes, cosmetics, cellulose based paper, photographic film paper, fibers, waxes, or inks.

In any of the same or other embodiments of the polymer composition, the organic polymeric material includes at least one of (i) polyethylene, polypropylene, polyisobutylene, polybut-1-ene, or poly-4-methylpent-1-ene; (ii) polyisoprene or polybutadiene; (iii) cyclopentene or norbornene; (iv) optionally crosslinked polyethylene, high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), very low density polyethylene (VLDPE), or ultralow density polyethylene (ULDPE); (v) thermoplastic olefins (TPO); or (vi) copolymers of at least one of mono-, di-, or cyclo-olefins.

In any of the same or other embodiments of the polymer composition, the amount of hindered phenol, organic phosphite, or combination thereof is from 0.001 to 5.0% by weight of the total weight of the polymer composition.

In the same or other embodiments of the polymer composition, the amount of hindered phenol, organic phosphite, or combination thereof is from 0.005 to 3.0% by weight of the total weight of the polymer composition.

In the same or other embodiments of the polymer composition, the amount of hindered phenol, organic phosphite, or combination thereof is from 0.01 to 1.0% by weight of the total weight of the polymer composition.

In any of the same or other embodiments of the polymer composition, the hindered phenol has at least one group according to Formulae (IVa), (IVb), or (IVc):

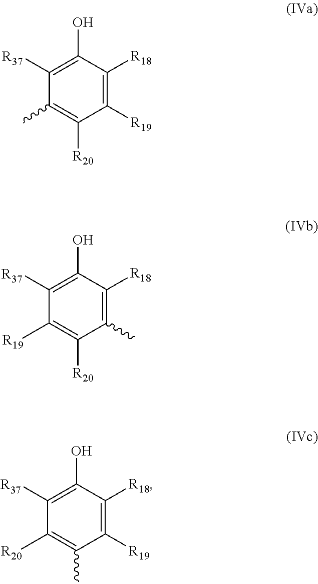

wherein:

“ [symbol] ” indicates the point of attachment (via a carbon-carbon single bond) of the molecular fragment to a parent compound;

R₁₈ and R₃₇ of Formulae (IVa), (IVb), or (IVc) are each independently a C₄₋₁₂ tertiary hydrocarbyl; and

R₁₉ and R₂₀ of Formulae (IVa), (IVb), or (IVc) are each independently hydrogen or C₁-C₂₀ hydrocarbyl.

In the same or other embodiments of the polymer composition, R₁₈ and R₃₇ of Formulae (IVa), (IVb), and (IVc) are each independently tert-butyl, 1,1-dimethylethyl, 1-methylcyclohexyl, or α,α-dimethylbenzyl.

In any of the same or other embodiments of the polymer composition, the hindered phenol includes at least one of:
3,5-di-tert-butyl-4-hydroxyanisole,
3,5-di-tert-butyl-4-hydroxyphenyl stearate,
bis(3,5-di-tert-butyl-4-hydroxyphenyl) adipate,
4,4′-methylenebis (2,6-di-tert-butylphenol),
2,2-bis(3,5-di-tert-butyl-4-hydroxyphenyl)propane,
3,5,3′,5′-tetra-tert-butyl-4,4′-dihydroxydibenzyl ether,
tris(3,5-di-tert-butyl-4-hydroxybenzyl)amine,
bis(3,5-di-tert-butyl-4-hydroxybenzyl) sulfide,
isooctyl 3,5-di-tert-butyl 4-hydroxybenzylmercaptoacetate,
didodecylmercaptoethyl 2,2-bis(3,5-di-tert-butyl-4-hydroxybenzyl)malonate,
di-[4-(1,1,3,3-tetramethylbutyl)phenyl]-2,2-bis(3,5-di-tert-butyl-4-hydroxybenzyl)malonate,
1,3,5-tris(3,5-di-tert-butyl-4-hydroxybenzyl)-2,4,6-trimethylbenzene,
1,4-bis(3,5-di-tert-butyl-4-hydroxybenzyl)-2,3,5,6-tetramethylbenzene,
2,4,6-tris-(3,5-di-tert-butyl-4-hydroxybenzyl)phenol,
2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-thiazine,
2-octylmercapto-4,6-bis (3,5-di-tert-butyl-4-hydroxyphenoxy)-1,3,5-triazine,
2,4,6-tris(3,5-di-tert-butyl-4-hydroxyphenoxy)-1,2,3-triazine,
1,3,5-tris(3,5-di-tert-butyl-4-hydroxybenzyl)isocyanurate,
2,4,6-tris(3,5-di-tert-butyl-4-hydroxyphenylethyl)-1,3,5-triazine,
1,3,5-tris(3,5-di-tert-butyl-4-hydroxyphenyl-propionyl)hexahydro-1,3,5-triazine,
amides of β-(3,5-di-tert-butyl-4-hydroxyphenyl)propionic acid,
N,N′-bis(3,5-di-tert-butyl-4-hydroxyphenylpropionyl)hexamethylenediamine,
N,N′-bis(3,5-di-tert-butyl-4-hydroxyphenylpropionyl)trimethylenediamine,
N,N′-bis(3,5-di-tert-butyl-4-hydroxyphenylpropionyl)hydrazine,
2,6-di-tert-butyl-N,N-dimethylamino-p-cresol,
4,4′-methylenebis(2,6-di-tert-butylphenol),
2,4-bis(n-octylthio)-6-(4-hydroxy-3,5-di-tert-butylanilino)-1,3,5-triazine,
1,6-hexanediyl 3,5-bis(1,1-dimethylethyl)-4-hydroxyphenylpropanoate,
octadecyl 3,5-di-tert-butyl-4-hydroxyhydrocinnamate,
tetrakis[methylene(3,5-di-tert-butyl-4-hydroxyhydrocinnamate)]methane,
esters of 3,5-di-tert-butyl-4-hydroxyphenylacetic acid,
thiodiethylenebis(3,5-di-tert-butyl-4-hydroxy)hydrocinnamate,
1,3,5-trimethyl-2,4,6-tris(3,5-di-tert-butyl-4-hydroxybenzyl)benzene, or
1,3,5-tris(3,5-di-tert-butyl-4-hydroxybenzyl)isocyanurate.

In any of the same or other embodiments of the polymer composition, the hindered phenol is at least one of pentaerythritol tetrakis(3-(3,5-di-tert-butyl-4-hydroxyphenyl)propionate) (IRGANOX™ 1010), octadecyl 3-(3,5-di-tert-butyl-4-hydroxyphenyl)propionate (IRGANOX™ 1076), 1,3,5-tris(3,5-di-tert-butyl-4-hydroxybenzyl)-1,3,5-triazine-2,4,6-(1H,3H,5H)-trione (IRGANOX™ 3114), or N,N′-bis(3,5-di-butyl-4-hydroxylphenyl propionyl)hydrazine (IRGANOX™ 1024).

In any of the same or other embodiments of the polymer composition, the organic phosphite is at least one of:

P(OR₁₇)₃, wherein each R₁₇ is independently C₁-C₂₄ alkyl, C₃-C₂₀ cycloalkyl, or C₄-C₂₀ alkylcycloalkyl;

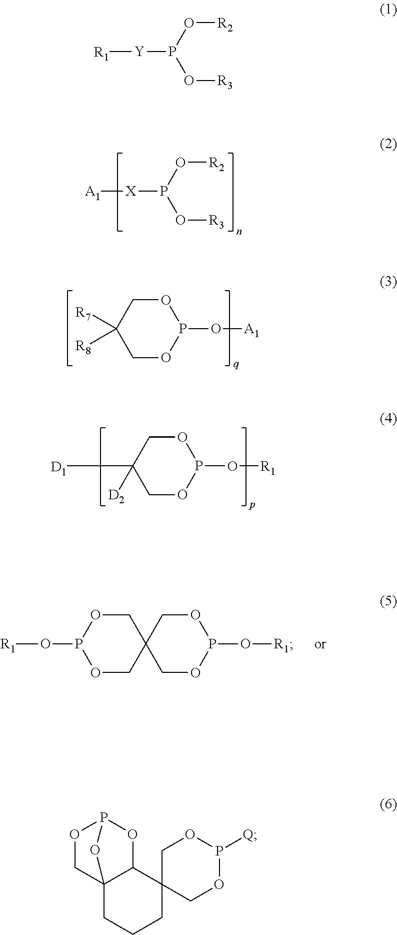

wherein:

the indices are integral and n is 2, 3 or 4; p is 1 or 2; q is 2 or 3; and z is 1 to 6;

X and Y are each oxygen;

A₁, if n or q is 2, is C₂-C₁₈ alkylene; C₂-C₁₂ alkylene interrupted by oxygen, sulfur or —NR₄—, or a divalent radical of the formula:

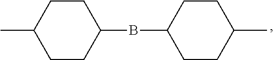

wherein B is a direct bond, —CH₂—, —CHR₄—, —CR₁R₄—, —S—, C₅-C₇ cycloalkylidene, or cyclohexylidene which is substituted by from 1 to 4 C₁-C₄ alkyl in position 3, 4 and/or 5;

A₁, if n or q is 3, is a trivalent carbon-centered radical of the formula CᵣH₂ᵣ₋₁, wherein r is an integer r from 4 to 12;

A₁, if n is 4, is a tetravalent radical of the formula:

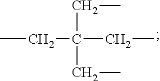

D₁, if p is 1, is C₁-C₄ alkyl and, if p is 2, is —CH₂OCH₂—;

D₂ is C₁-C₄ alkyl;

Q is the radical of an at least z-valent mono- or poly-alcohol, this radical being attached via the oxygen atom of the OH group of the mono- or poly-alcohol to the phosphorus atom;

R₁, R₂ and R₃ are each independently C₁-C₂₄ alkyl which is unsubstituted or substituted by halogen, —COOR₄, —CN or —CONR₄R₄, C₂-C₁₈ alkyl interrupted by oxygen, sulfur or —NR₄—, or C₅-C₁₂ cycloalkyl;

R₄ is independently hydrogen, C₁-C₈ alkyl, or C₅-C₁₂ cycloalkyl;

R₇ and R₈, if q is 2, are each independently C₁-C₄ alkyl or together are a 2,3-dehydropentamethylene radical; and

R₇ and R₈, if q is 3, are methyl.

In any of the same or other embodiments of the polymer composition, the organic phosphite is at least one of trilauryl phosphite, trioctadecyl phosphite, tristearyl sorbityl triphosphite, or a phosphite of the formula:

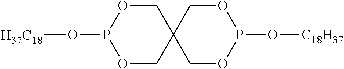

(distearyl pentaerythrityl diphosphite).

In any of the same or other embodiments of the polymer composition, the polymer composition further comprises 0.001 to 10 wt. %, preferably 0.01 to 5 wt. %, and more preferably from 0.02 to 2.5 wt. %, based on the weight of the organic polymer, of at least one hindered amine light stabilizer (HALS), UV absorber (UVA), hindered benzoate, thiosynergist, nickel phenolate, hydroxylamine, benzofuranone, nitrone, or inorganic UV screener.

In any of the same or other embodiments, the polymer composition further comprises a hindered amine light stabilizer (HALS) having at least one group according to Formula (II):

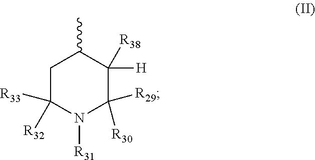

wherein:
R₃₁ is hydrogen, OH, C₁-C₂₀ hydrocarbyl, —CH₂CN, C₁-C₁₂ acyl, or C₁-C₁₈ alkoxy;
R₃₈ is hydrogen or C₁-C₈ hydrocarbyl; and
R₂₉, R₃₀, R₃₂, and R₃₃ are each independently C₁-C₂₀ hydrocarbyl, or R₂₉ and R₃₀ and/or R₃₂ and R₃₃ taken together with the carbon to which they are attached form a C₅-C₁₀ cycloalkyl; or

a group according to Formula (IIa):

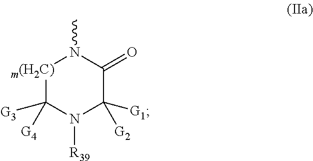

wherein:

m is an integer from 1 to 2;

R₃₉ is hydrogen, OH, C₁-C₂₀ hydrocarbyl, —CH₂CN, C₁-C₁₂ acyl, or C₁-C₁₈ alkoxy; and

G₁-G₄ are each independently C₁-C₂₀ hydrocarbyl.

In the same or other embodiments of the polymer composition, the hindered amine light stabilizer (HALS) is at least one of:
bis(2,2,6,6-tetramethylpiperidin-4-yl) sebacate (TINUVIN™ 770);
bis(2,2,6,6-tetramethylpiperidin-4-yl) succinate;
bis(1,2,2,6,6-pentamethylpiperidin-4-yl) sebacate;
bis(1-octyloxy-2,2,6,6-tetramethylpiperidyl) succinate;
bis(1-octyloxy-2,2,6,6-tetramethylpiperidin-4-yl) sebacate (TINUVIN™ 123);
bis(1,2,2,6,6-pentamethylpiperidin-4-yl) n-butyl 3,5-di-tert-butyl-4-hydroxybenzylmalonate;
a condensate of 1-(2-hydroxyethyl)-2,2,6,6-tetramethyl-4-hydroxypiperidine and succinic acid (TINUVIN™ 622);
2,2,6,6-tetramethylpiperidin-4-yl stearate;
2,2,6,6-tetramethylpiperidin-4-yl dodecanoate;
1,2,2,6,6-pentamethylpiperidin-4-yl stearate;
1,2,2,6,6-pentamethylpiperidin-4-yl dodecanoate;
a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);
tris(2,2,6,6-tetramethylpiperidin-4-yl) nitrilotriacetate;
4-stearyloxy-2,2,6,6-tetramethylpiperidine;
a condensate of N,N′-bis(2,2,6,6-tetramethylpiperidin-4-yl)hexamethylenediamine and 4-morpholino-2,6-dichloro-1,3,5-triazine (CYASORB™ UV-3346);
a condensate of N,N′-bis(2,2,6,6-tetramethylpiperidin-4-yl)hexamethylenediamine and 4-morpholino-2,6-dichloro-1,3,5-triazine, methylated (CYASORB™ UV-3529);
a condensate of 2-chloro-4,6-bis(4-n-butylamino-2,2,6,6-tetramethylpiperidyl)-1,3,5-triazine and 1,2-bis(3-aminopropylamino)ethane (CHIMASSORB™ 119);
a condensate of 2-chloro-4,6-bis(4-n-butylamino-1,2,2,6,6-pentamethylpiperidyl)-1,3,5-triazine and 1,2-bis-(3-aminopropylamino)ethane;
a condensate of N,N′-bis(2,2,6,6-tetramethylpiperidin-4-yl)hexamethylenediamine, 2,2,6,6-tetramethyl-4-n-butylaminopiperidine, di-n-butyl amine, and 2,4,6-trichloro-1,3,5-triazine (CHIMASSORB™ 2020);
a mixture of 4-hexadecyloxy- and 4-stearyloxy-2,2,6,6-tetramethylpiperidine;
a mixture of 4-hexadecyloxy- and 4-stearyloxy-1,2,2,6,6-pentamethylpiperidine;
a condensate of N,N′-bis(2,2,6,6-tetramethylpiperidin-4-yl)hexamethylenediamine and 4-cyclohexylamino-2,6-dichloro-1,3,5-triazine;
a condensate of 1,2-bis(3-aminopropylamino)ethane, 2,4,6-trichloro-1,3,5-triazine, and 4-n-butylamino-2,2,6,6-tetramethylpiperidine;
a condensate of N,N′-bis(2,2,6,6-tetramethylpiperidin-4-yl)hexamethylenediamine and 4-cyclohexylamino-2,6-dichloro-1,3,5-triazine;
tetrakis(2,2,6,6-tetramethylpiperidin-4-yl)-1,2,3,4-butanetetracarboxylate;
tetrakis(1,2,2,6,6-pentamethylpiperidin-4-yl)-1,2,3,4-butanetetracarboxylate;
1,2,3,4-butanetetracarboxylic acid, 2,2,6,6-tetramethylpiperidin-4-yl tridecyl ester;
1,2,3,4-butanetetracarboxylic acid, 1,2,2,6,6-pentamethylpiperidin-4-yl tridecyl ester;
N,N′-1,6-hexanediylbis[N-(2,2,6,6-tetramethylpiperidin-4-yl)formamide (UVINUL™ 4050);
a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);
a condensate of N,N′-bis(2,2,6,6-tetramethyl-1-(propyloxy)-piperidin-4-yl)hexamethylenediamine, 1-propyloxy-2,2,6,6-tetramethyl-4-n-butylaminopiperidine, di-n-butyl amine, and 2,4,6-trichloro-1,3,5-triazine (TINUVIN™ NOR HALS 371);
N,N′-bis(2,2,6,6-tetramethylpiperidin-4-yl)hexamethylenediamine, polymer with 2,4,6-trichloro-1,3,5-triazine, reaction products with 3-bromo-1-propene, di-n-butylamine, and 2,2,6,6-tetramethyl-4-n-butylpiperidine, oxidized, and hydrogenated (TINUVIN™ XT 200);
TINUVIN™ XT-850/XT-855; or
N¹,N^{1′}-1,2-ethanediylbis(1,3-propanediamine), reaction products with cyclohexane and peroxidized N-butyl-2,2,6,6-tetramethyl-4-piperidinamine-2,4,6-trichloro-1,3,5-triazine (FLAMESTAB™ NOR 116).

In any of the same or other embodiments, the polymer composition further comprises at least one 2-(2′-hydroxyphenyl)-s-triazine, 2-hydroxybenzophenone, 2-(2′-hydroxyphenyl)benzotriazole, or benzoxazinone.

In any of the same or other embodiments, the polymer composition further comprises at least one 2-(2′-hydroxyphenyl)-s-triazine according to Formula (I):

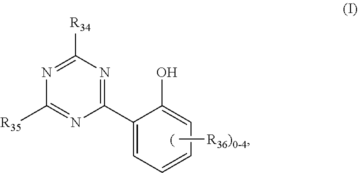

wherein each R₃₄ and R₃₅ is independently a C₆-C₁₀ aryl group, mono- or di-C₁-C₁₂ hydrocarbyl-substituted amino, C₂-C₁₂ alkanoyl, C₁-C₁₂ alkyl, C₁-C₁₀ acyl, or C₁-C₁₀ alkoxyl,

wherein the C₆-C₁₀ aryl group is optionally substituted at from 1 to 3 substitutable positions with at least one of OH, halogen, C₁-C₁₂ alkyl, C₁-C₁₂ alkoxy, C₁₋₁₂ alkoxyester, C₂₋₁₂ alkanoyl, or phenyl, wherein the phenyl is optionally substituted at from 1 to 3 substitutable positions with at least one of OH, halogen, C₁₋₁₂ alkyl, C₁₋₁₂ alkoxy, C₁₋₁₂ alkoxyester, or C₂₋₁₂ alkanoyl; and

each R₃₆ is independently OH, halogen, C₁-C₁₂ alkyl, C₁-C₁₂ alkoxy, C₁-C₁₂ alkoxyester, C₂-C₁₂ alkanoyl, phenyl, or C₁-C₁₂ acyl.

In any of the same or other embodiments of the polymer composition, the 2-(2′-hydroxyphenyl)-s-triazine is at least one of 4,6-bis-(2,4-dimethylphenyl)-2-(2-hydroxy-4-octyloxyphenyl)-s-triazine (CYASORB™ 1164), 2,4-bis[2-hydroxy-4-(2-hydroxy-4-(2-hydroxy-ethoxy)phenyl]-6-(2,4-dimethylphenyl)-s-triazine, 2,4-bis(4-biphenylyl)-6-[2-hydroxy-4-[(octyloxycarbonyl)ethylideneoxy]phenyl]-s-triazine, 2,4-bis(4-biphenylyl)-6-[2-hydroxy-4-(2-ethylhexyloxy)phenyl]-s-triazine (TINUVIN™ 1600), 2,4,6-tris[2-hydroxy-4-(3-sec-butyloxy-2-hydroxypropyloxy)-phenyl]-s-triazine, mixture of 4,6-bis-(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine (TINUVIN™ 400), 4,6-bis-(2,4-dimethylphenyl)-2-(2-hydroxy-4(3-(2-ethylhexyloxy)-2-hydroxypropoxy)-phenyl)-s-triazine, or 4,6-diphenyl-2-(4-hexyloxy-2-hydroxyphenyl)-s-triazine (TINUVIN™ 1577).

In the same or other embodiments of the polymer composition, the 2-hydroxybenzophenone is at least one of 2-hydroxy-4-methoxybenzophenone (CYASORB™ UV-9), 2,2′-dihydroxy-4-methoxybenzophenone (CYASORB™ UV-24), 2-hydroxy-4-octyloxybenzophenone (CYASORB™ UV-531), 2,2′-dihydroxy-4,4′-di-methoxybenzophenone, 2,2′-dihydroxybenzophenone, 2,2′,4,4′-tetrahydroxybenzophenone, 2,2′-dihydroxy-4,4′-dimethoxybenzophenone, 2,2′-dihydroxy-4,4′-diethoxybenzophenone, 2,2′-dihydroxy-4,4′-dipropoxybenzophenone, 2,2′-dihydroxy-4,4′-dibutoxybenzophenone, 2,2′-dihydroxy-4-methoxy-4′-ethoxybenzophenone, 2,2′-dihydroxy-4-methoxy-4′-propoxybenzophenone, 2,2′-dihydroxy-4-methoxy-4′-butoxybenzophenone, 2,2′-dihydroxy-4-ethoxy-4′-propoxybenzophenone, 2,2′-dihydroxy-4-ethoxy-4′-butoxybenzophenone, 2,3′-dihydroxy-4,4′-dimethoxybenzophenone, 2,3′-dihydroxy-4-methoxy-4′-butoxybenzophenone, 2-hydroxy-4,4′,5′-trimethoxybenzophenone, 2-hydroxy-4,4′,6′-tributoxybenzophenone, 2-hydroxy-4-butoxy-4′,5′-dimethoxybenzophenone, 2-hydroxy-4-ethoxy-2′,4′-dibutylbenzophenone, 2-hydroxy-4-propoxy-4′,6′-dichlorobenzophenone, 2-hydroxy-4-propoxy-4′,6′-dibromobenzophenone, 2,4-dihydroxybenzophenone, 2-hydroxy-4-ethoxybenzophenone, 2-hydroxy-4-propoxybenzophenone, 2-hydroxy-4-butoxybenzophenone, 2-hydroxy-4-methoxy-4′-methylbenzophenone, 2-hydroxy-4-methoxy-4′-ethylbenzophenone, 2-hydroxy-4-methoxy-4′-propylbenzophenone, 2-hydroxy-4-methoxy-4′-butylbenzophenone, 2-hydroxy-4-methoxy-4′-tert-butylbenzophenone, 2-hydroxy-4-methoxy-4′-chlorobenzophenone, 2-hydroxy-4-methoxy-2′-chlorobenzophenone, 2-hydroxy-4-methoxy-4′-bromobenzophenone, 2-hydroxy-4,4′-dimethoxybenzophenone, 2-hydroxy-4,4′-dimethoxy-3-methylbenzophenone, 2-hydroxy-4,4′-dimethoxy-2′-ethylbenzophenone, 2-hydroxy-4,4′,5′-trimethoxybenzophenone, 2-hydroxy-4-ethoxy-4′-methylbenzophenone, 2-hydroxy-4-ethoxy-4′-ethylbenzophenone, 2-hydroxy-4-ethoxy-4′-propylbenzophenone, 2-hydroxy-4-ethoxy-4′-butylbenzophenone, 2-hydroxy-4-ethoxy-4′-methoxybenzophenone, 2-hydroxy-4,4′-diethoxybenzophenone, 2-hydroxy-4-ethoxy-4′-propoxybenzophenone, 2-hydroxy-4-ethoxy-4′-butoxybenzophenone, 2-hydroxy-4-ethoxy-4′-chlorobenzophenone, or 2-hydroxy-4-ethoxy-4′-bromobenzophenone.

In the same or other embodiments of the polymer composition, the 2-(2′-hydroxyphenyl)benzotriazole is at least one of 2-(2′-hydroxy-5′-methylphenyl)benzotriazole (TINUVIN™ P), 2-(2′-hydroxy-5′-tert-butylphenyl)benzotriazole, 2-(2′-hydroxy-3′-methyl-5′-tert-butylphenyl)benzotriazole, 2-(2′-hydroxy-5′-cyclohexylphenyl)benzotriazole, 2-(2′-hydroxy-3′,5′-dimethylphenyl)benzotriazole, 2-(2′-hydroxy-5′-tert-butylphenyl)-5-chloro-benzotriazole, 2-(2′-hydroxy-5′-tert-octylphenyl)benzotriazole (CYASORB™ UV-5411), 2-(3′,5′-di-tert-butyl-2′-hydroxyphenyl)-5-chlorobenzotriazole, 2-(3′,5′-di-tert-amyl-2′-hydroxyphenyl)benzotriazole (CYASORB™ UV-2337), 2-(3′,5′-bis(α,α-dimethylbenzyl)-2′-hydroxyphenyl)benzotriazole (TINUVIN™ 900), 2-(3′-tert-butyl-2′-hydroxy-5′-(2-octyloxycarbonylethyl)phenyl)benzotriazole, 2,2′-methylenebis[4-(1,1,3,3-tetramethylbutyl)-6-benzotriazole-2-ylphenol], the transesterification product of 2-[3′-tert-butyl-5′-(2-methoxycarbonylethyl)-2′-hydroxyphenyl]-2H-benzotriazole with polyethylene glycol 300 (TINUVIN™ 1130), 2-[2′-hydroxy-3′-(α,α-dimethylbenzyl)-5′-(1,1,3,3-tetramethylbutyl)phenyl]benzotriazole, 5-trifluoromethyl-2-(2-hydroxy-3-α-cumyl-5-tert-octylphenyl)benzotriazole, 2-(2′-hydroxy-5′-(2-hydroxyethyl)phenyl)benzotriazole, 2-(2′-hydroxy-5′-(2-methacryloyloxyethyl)phenyl)benzotriazole, 2-(2′-hydroxy-3′-tert-butyl-5′-methylphenyl)-5-chlorobenzotriazole (TINUVIN™ 326), 2-(3′-sec-butyl-5′-tert-butyl-2′-hydroxyphenyl)benzotriazole, 2-(3′,5′-di-tert-butyl-2′-hydroxyphenyl)benzotriazole, 2-(3′-dodecyl-5′-methyl-2′-hydroxyphenyl)-benzotriazole, 2-(3′-tert-butyl-5′-(2-octyloxycarbonylethyl)-2′-hydroxyphenyl)-5-chlorobenzotriazole, 2-(5′-methyl-2′-hydroxyphenyl)benzotriazole, 2-(5′-tert-butyl-2′-hydroxyphenyl)benzotriazole, or 2-(2′-hydroxy-3′-di-tert-butylphenyl)benzotriazole.

In the same or other embodiments of the polymer composition, the benzoxazinone is at least one of 2-methyl-3,1-benzoxazin-4-one, 2-butyl-3,1-benzoxazin-4-one, 2-phenyl-3,1-benzoxazin-4-one, 2-(1- or 2-naphthyl)-3,1-benzoxazin-4-one, 2-(4-biphenyl)-3,1-benzoxazin-4-one, 2-p-nitrophenyl-3,1-benzoxazin-4-one, 2-m-nitrophenyl-3,1-benzoxazin-4-one, 2-p-benzoylphenyl-3,1-benzoxazin-4-one, 2-p-methoxyphenyl-3,1-benzoxazin-4-one, 2-O-methoxyphenyl-3,1-benzoxazin-4-one, 2-cyclohexyl-3,1-benzoxazin-4-one, 2-p-(or m-)phthalimidephenyl-3,1-benzoxazin-4-one, N-phenyl-4-(3,1-benzoxazin-4-one-2-yl)phthalimide, N-benzoyl-4-(3,1-benzoxazine-4-one-2-yl)aniline, N-benzoyl-N-methyl-4-(3,1-benzoxazin-4-one-2-yl)-aniline, 2-[p-(N-phenylcarbamonyl)phenyl]-3,1-benzoxazin-4-one, 2-[p-(N-phenyl N-methylcarbamoyl)phenyl]-3,1-benzoxazin-4-one, 2,2′-bis(3,1-benzoxazin-4-one), 2,2′-ethylenebis(3,1-benzoxazin-4-one), 2,2′-tetramethylenebis(3,1-benzoxazin-4-one), 2,2′-hexamethylenebis(3,1-benzoxazin-4-one), 2,2′-decamethylenebis(3,1-benzoxazin-4-one), 2,2′-p-phenylenebis(3,1-benzoxazin-4-one) (CYASORB™ UV-3638), 2,2′-m-phenylenebis(3,1-benzoxazin-4-one), 2,2′-(4,4′-diphenylene)bis(3,1-benzoxazin-4-one), 2,2′-(2,6- or 1,5-naphthalene)bis(3,1-benzoxazin-4-one), 2,2′-(2-methyl-p-phenylene)bis(3,1-benzoxazin-4-one), 2,2′-(2-nitro-p-phenylene)bis(3,1-benzoxazin-4-one), 2,2′-(2-chloro-p-phenylene)bis(3,1-benzoxazin-4-one), 2,2′-(1,4-cyclohexylene)bis(3,1-benzoxazin-4-one), N-p-(3,1-benzoxazin-4-on-2-yl)phenyl, 4-(3,1-benzoxazin-4-on-2-yl)phthalimide, N-p-(3,1-benzoxazin-4-on-2-yl)benzoyl, 4-(3,1-benzoxazin-4-on-2-yl)aniline, 1,3,5-tri(3,1-benzoxazin-4-on-2-yl)benzene, 1,3,5-tri(3,1-benzoxazin-4-on-2-yl)naphthalene, or 2,4,6-tri(3,1-benzoxazin-4-on-2-yl)naphthalene.

In any of the same or other embodiments, the polymer composition further comprises a hindered benzoate according to Formula (VI):

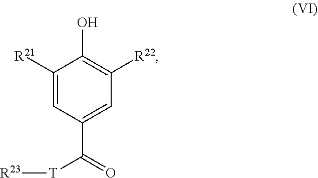

wherein:

each of R²¹ and R²² is independently a C₁-C₁₂ alkyl;

T is O or NR²⁴, wherein R²⁴ is H or a C₁-C₃₀ hydrocarbyl; and

R²³ is H or a C₁-C₃₀ hydrocarbyl.

In the same or other embodiments of the polymer composition, the hindered benzoate is at least one of 2,4-di-tert-butylphenyl-3,5-di-tert-butyl-4-hydroxybenzoate, hexadecyl-3,5-di-tert-butyl-4-hydroxybenzoate (CYASORB™ UV-2908), octadecyl-3,5-di-tert-butyl-4-hydroxybenzoate, octyl-3,5-di-tert-butyl-4-hydroxybenzoate, decyl-3,5-di-tert-butyl-4-hydroxybenzoate, dodecyl-3,5-di-tert-butyl-4-hydroxybenzoate, tetradecyl-3,5-di-tert-butyl-4-hydroxybenzoate, behenyl-3,5-di-tert-butyl-4-hydroxybenzoate, 2-methyl-4,6-di-tert-butylphenyl-3,5-di-tert-butyl-4-hydroxybenzoate, or butyl-3-[3-tert-butyl-4-(3,5-di-tert-butyl-4-hydroxybenzoyloxy)phenyl]propionate.

In any of the same or other embodiments of the polymer composition, the thiosynergist is at least one of dilauryl 3,3′-thiodipropionate, dimyristyl 3,3′-thiodipropionate, ditridecyl 3,3′-thiodipropionate, distearyl 3,3′-thiodipropionate, pentaerythritol tetrakis-(3-dodecylthiopropionate), a tetraalkyl thioethyl thiodisuccinate, 2,12-dihydroxy-4,10-dithia-7-oxatridecamethylene bis[3-(dodecylthio)propionate], 2-mercaptobenzimidazole, 2-mercaptobenzimidazole, zinc salt, zinc dibutyldithiocarbamate, or dioctadecyl disulfide.

In any of the same or other embodiments, the polymer composition further comprises at least one of titanium dioxide, barium sulfate, zinc oxide, or cerium(IV) oxide.

The present invention also provides multiple embodiments of a stabilized polymeric article comprising the polymer composition of any one of the foregoing embodiments.

In the same or other embodiments of the stabilized polymeric article, reduced discoloration is associated with the use of specific hindered phenols and the organic phosphites compared to other hindered phenols and organic phosphites.

Multiple embodiments for methods of reducing discoloration of an organic polymeric material upon exposure to UV-C (190-280 nm) light are also provided herein, said methods comprising adding to the organic polymeric material a stabilizing amount of a hindered phenol, an organic phosphite, or a combination thereof, with the provisos that:
a) the OH group on the aromatic ring of the hindered phenol is flanked by tertiary-hydrocarbyl groups, and
b) the organic phosphite does not have any —OAr group linked directly to the P of the phosphite, wherein Ar represents an unsubstituted or substituted aryl group;

wherein reduced discoloration is associated with the use of specific hindered phenols and the organic phosphites compared to other hindered phenols and organic phosphites, even in the absence of other polymer additives including UV absorbers, hindered amine light stabilizers (HALS), metal oxides and/or barium salts.

In the same or other embodiments of the methods of reducing discoloration of an organic polymeric material exposed to UV-C light, the stabilizing amount of the hindered phenol, organic phosphite, or combination thereof is from 0.001 to 5.0% by weight of the total weight of the polymer composition.

### EXAMPLES

The following examples are provided to assist one skilled in the art to further understand certain embodiments defined herein. These examples are intended for illustration purposes and are not to be construed as limiting the scope of the various embodiments as defined by the claims. The discoloration of various hindered phenols and organic phosphites upon exposure to UV-C light was evaluated in these examples.

### Example 1—UV-C Weathering Performance (Delta E and Delta YI) of Polypropylene Plagues Containing Various Hindered Phenols

Polypropylene homopolymer (PRO-FAX™ 6301 NT) from LyondellBasell was the polymer matrix for the weathering studies. Information regarding the trade names, suppliers, and chemical names of the hindered phenols used in this example are listed in Table 1. These hindered phenols may be available from other suppliers under different trade names than specified. All additive materials are used as received.

TABLE 1
Trade Names, Suppliers, and Chemical Names of Hindered
Phenols Used in UV-C Weathering Studies

| Trade Name | Chemical Name |
|---|---|
| IRGANOX ™ 1010 | Pentaerythritol tetrakis(3-(3,5-di-tert-butyl- |
| (BASF) | 4-hydroxyphenyl)propionate) |
| IRGANOX ™ 1076 | Octadecyl 3-(3,5-di-tert-butyl-4- |
| (BASF) | hydroxyphenyl)propionate |
| CYANOX ™ 1790 | 1,3,5-Tris(4-tert-butyl-3-hydroxy-2,6-dimethyl |
| (Solvay) | benzyl)-1,3,5-triazine-2,4,6-(1H,3H,5H)-trione |
| IRGANOX ™ 3114 | 1,3,5-Tris(3,5-di-tert-butyl-4-hydroxybenzyl)- |
| (BASF) | 1,3,5-triazine-2,4,6(1H,3H,5H)-trione |
| IRGANOX ™ 1024 | N,N′-Bis(3,5-di-tert-butyl-4-hydroxylphenyl |
| (BASF) | propionyl)hydrazine |

The general procedure for the preparation of plaques containing the hindered phenols is as follows. 800 Grams powder mixtures of each formulation are prepared by dry blending the hindered phenol with the polypropylene resin. The mixtures are then compounded at 230° C. with a Werner & Pfleiderer twin screw extruder. After extrusion, standard rectangular plaques (2×2.5×0.125 inch) are injection molded at 200° C. into rectangular plaques with an Auburg injection molding machine.

For UV-C weathering studies, a UV-C weathering apparatus was developed and assembled in-house. The apparatus contains two low-pressure, narrow band UV-C lamps (254 nm) with an average irradiance of ca. 1200 μW/cm² (at 254 nm) at the plaque surface as well as an automatic fan controller in order to maintain the test temperature below 40° C. During the UV-C weathering tests, plaques are placed inside the apparatus and repositioned frequently to ensure all samples received an equal amount of radiant exposure.

The changes in color (delta E) and in Yellowness Index (delta YI) of the plaque surface after UV-C exposure is used to evaluate surface discoloration. Both the color and YI measurements are conducted using an X-Rite Color i7 spectrophotometer using the Hunter L, a, b color scale according to ASTM D2244-16 (for color) and ASTM E313-20 (for YI). Delta E is calculated by subtracting the initial color (time=0 hour) from the color after 72 hours of UV-C exposure, and delta YI was calculated by subtracting the initial YI (time=0 hour) from the YI after 72 hours of UV-C exposure.

TABLE 2
UV-C Weathering Performance of Polypropylene with
Various Hindered Phenols.

| | | YI | Delta YI | Delta E |
|---|---|---|---|---|
| Sample | Formulation | (0 hours) | (72 hours) | (72 hours) |
| 2-1 | 100% Polypropylene | 9.14 | 0.74 | 0.52 |
| 2-2 | 99.90% Polypropylene + | 10.95 | 13.85 | 7.23 |
| | 0.10% IRGANOX ™ 1010 | | | |
| 2-3 | 99.90% Polypropylene + | 12.21 | 9.41 | 4.92 |
| | 0.10% IRGANOX ™ 1076 | | | |
| 2-4 | 99.90% Polypropylene + | 10.27 | 27.11 | 12.79 |
| | 0.10% CYANOX ™ 1790 | | | |
| 2-5 | 99.90% Polypropylene + | 11.11 | 15.61 | 7.91 |
| | 0.10% IRGANOX ™ 3114 | | | |

The data in Table 2 demonstrates that polypropylene formulated with hindered phenols discolors after UV-C exposure. However, the phenolic antioxidants flanked by two tertiary hydrocarbyl groups (tert-butyl, Samples 2-2, 2-3, and 2-5) show less discoloration than the phenolic flanked by one tertiary hydrocarbyl group and one methyl group (Sample 2-4).

### Example 2—Color Changes of Hindered Phenols (Neat, without Polypropylene Resin) after UV-C Exposure

Color changes of selected hindered phenols from Table 2 upon UV-C exposure is investigated in neat form (i.e., in the absence of the polypropylene). The neat samples are placed in Petri dishes with the glass lid removed for direct UV-C weathering using the custom-made UV-C apparatus described above. All samples are exposed to UV-C light for 6 or 12 hours without shuffling or repositioning as the study is qualitative. Color changes of additives are observed visually and recorded by camera.

TABLE 3
Color Changes of Neat Hindered Phenols after UV-C Exposure

| | | Exposure | | Corre- |
|---|---|---|---|---|
| | | Time | | sponding |
| Sample | Additive | (hours) | Color Change | Figure |
| 3-1 | CYANOX ™ 1790 | 12 | White → | 1A |
| | | | Yellow | |
| 3-2 | IRGANOX ™ 3114 | 12 | White → Blue | 1B |
| 3-3 | IRGANOX ™ 1076 | 12 | White → Blue | 1C |
| 3-4 | IRGANOX ™ 1010 | 12 | White → | 1D |
| | | | Light Blue | |
| 3-5 | IRGANOX ™ 1024 | 6 | White → Blue | 1E |

Samples 3-2 to 3-5 demonstrate that hindered phenols wherein the OH group is flanked by two tert-hydrocarbyl groups (tert-butyl) show more favorable discoloration (i.e., turning from white to blue rather than from white to yellow) after UV-C light exposure compared to Sample 3-1, wherein the OH group is flanked by one tert-hydrocarbyl groups (tert-butyl) and one methyl group. These observations are consistent with the results of Example 1 in Table 2.

### Example 3—UV-C Weathering Performance (Delta E and Delta YI) of Polypropylene Articles Containing Various Organic Phosphites

Polypropylene homopolymer (PRO-FAX™ 6301 NT) from LyondellBasell is the polymer matrix for the weathering studies. Information regarding the trade names, suppliers, and chemical names of the organic phosphites used in this example are listed in Table 4. These organic phosphites may be available from other suppliers under different trade names than specified. All organic phosphites are used as received.

TABLE 4
Trade Names, Suppliers, and Chemical Names of Organic
Phosphites Used in UV-C Weathering Studies

| Trade Name | Chemical Name |
|---|---|
| IRGAFOS ™ 168 (BASF) | Tris(2,4-di-tert-butylphenyl) phosphite |
| WESTON ™ 618 (Addivant) | Distearyl Pentaerythritol Diphosphite |
| WESTON ™ 626 (Addivant) | Bis(2,4-di-tert-butylphenyl) |
| | Pentaerythritol Diphosphite |
| DOVERPHOS ™ 9228 | Bis(2,4-dicumylphenyl) Pentaerythritol |
| (Dover Chemical) | Diphosphite |

The general procedure for the preparation of plaques containing the organic phosphites is as follows. 800 Grams powder mixtures of each formulation are prepared by dry blending the organic phosphite with the polypropylene resin. The mixtures are then compounded at 230° C. with a Werner & Pfleiderer twin screw extruder. After extrusion, standard rectangular plaques (2×2.5×0.125 inch) are injection molded at 200° C. into rectangular plaques with an Auburg injection molding machine.

For UV-C weathering studies, a UV-C weathering apparatus was developed and assembled in-house. The apparatus contains two low-pressure, narrow band UV-C lamps (254 nm) with an average irradiance level of ca. 1200 μW/cm² (at 254 nm) at the plaque surface as well as an automatic fan controller in order to maintain the test temperature below 40° C. During the UV-C weathering tests, plaques are placed inside the apparatus and repositioned frequently to ensure all samples received an equal amount of radiant exposure.

The changes in color (delta E) and in Yellowness Index (delta YI) of the plaque surface after UV-C exposure is used to evaluate surface discoloration. Both the color and YI measurements are conducted using an X-Rite Color i7 spectrophotometer using Hunter L, a, b color scale (for color) and ASTM E313 (for YI), respectively. Delta E was calculated by subtracting the initial color reading (time=0 hour) from the color reading after 72 hours of UV-C exposure.

TABLE 5
UV-C Weathering Performance of Polypropylene Plaques
with Various Organic Phosphites.

| | | YI | Delta YI | Delta E |
|---|---|---|---|---|
| | | (0 | (72 | (72 |
| Sample | Formulation | hours) | hours) | hours) |
| 5-1 | 100% Polypropylene | 9.14 | 0.74 | 0.51 |
| 5-2 | 99.85% Polypropylene + | 9.35 | 19.08 | 9.15 |
| | 0.15% IRGAFOS ™ 168 | | | |
| 5-3 | 99.85% Polypropylene + | 8.48 | 1.56 | 0.94 |
| | 0.15% WESTON ™ 618 | | | |
| 5-4 | 99.85% Polypropylene + | 8.73 | 20.08 | 9.74 |
| | 0.15% WESTON ™ 626 | | | |
| 5-5 | 99.85% Polypropylene + | 9.34 | 18.86 | 9.15 |
| | 0.15% DOVERPHOS ™ 9228 | | | |

The data in Table 5 demonstrates that polypropylene formulated with organic phosphites containing —OAr groups attached to the phosphorus atom exhibits significant discoloration upon UV-C exposure (Samples 5-2, 5-4, and 5-5). Surprisingly, however, polypropylene formulated with an organic phosphite containing no —OAr groups attached to the phosphorus atom exhibit minimal discoloration after UV-C exposure (Sample 5-3).

### Example 4—UV-C Weathering Performance (Delta E and Delta YI) of Polyethylene Plagues Containing Various Hindered Phenols and Phosphites

High density polyethylene (SCLAIR® 2909) from NOVA Chemicals is used as the polymer matrix for these weathering studies. The hindered phenols and phosphites used in this example are listed in either Table 1 or Table 4, supra. All additive materials were used as received.

The general procedure for the preparation of polyethylene plaques containing the hindered phenols is as follows. 800 grams powder mixtures of each formulation are prepared by dry blending the hindered phenol with the polyethylene resin. The mixtures were then compounded at 190° C. with a Werner & Pfleiderer twin screw extruder. After extrusion, standard rectangular plaques (2×2.5×0.125 inch) were injection molded at 190° C. into rectangular plaques with an Engel injection molding machine.

The general procedure for preparing polyethylene plaques containing the phosphites is the same as that for preparing hindered phenols described above.

The UV-C weathering studies are performed as detailed in the prior examples, using the UV-C weathering apparatus as described. Changes in color (delta E) and in Yellowness Index (delta YI) of the plaque surface after UV-C exposure are also determined in the same manner. Results of the UV-C weathering performance of polyethylene with various hindered phenols and phosphites are presented below in Table 6.

TABLE 6
UV-C Weathering Performance of Polyethylene with
Various Hindered Phenols and Phosphites

| | | YI | Delta YI | Delta E |
|---|---|---|---|---|
| Sample | Formulation | (0 hours) | (24 hours) | (24 hours) |
| 6-1 | 100% Polyethylene | 1.93 | 7.97 | 4.62 |
| 6-2 | 99.90% Polyethylene + | 0.15 | 11.51 | 6.77 |
| | 0.10% IRGANOX ™ 1010 | | | |
| 6-3 | 99.90% Polyethylene + | 6.04 | 13.75 | 7.62 |
| | 0.10% IRGANOX ™ 1076 | | | |
| 6-4 | 99.90% Polyethylene + | −1.55 | 17.78 | 10.40 |
| | 0.15% IRGAFOS ™ 168 | | | |
| 6-5 | 99.90% Polyethylene + | −0.47 | 9.29 | 5.55 |
| | 0.15% WESTON ™ 618 | | | |

The data in Table 6 demonstrates that polyethylene formulated with an organic phosphite containing no —OAr groups attached to the phosphorus atom exhibits minimal discoloration after UV-C exposure compared to the sample with IRGAFOS™ 168 (sample 6-4 versus 6-5).

The results presented in these foregoing examples clearly and convincingly demonstrate that the polymer compositions as described and claimed herein are resistant to discoloration when subjected to exposure to UV-C (190-280 nm) disinfectant (germicidal) light compared to polymer compositions comprising other hindered phenols and organic phosphites.

### Example 5—Impact of 254 nm UV-C Exposure on Polycarbonate Materials

Polycarbonate is known to be a high-performance engineering thermoplastic used in a variety of applications including but not limited to compact discs, safety helmets, bullet-proof glass, safety glasses, and car headlamp lenses. Although any polymer linked together by carbonate groups (—O—(C═O)—O—) could be considered a polycarbonate, the most ubiquitous one used is based on bisphenol A (BPA). Polycarbonate has many advantageous properties including high impact strength, high toughness, optical clarity, chemical resistance, heat resistance, high dimensional stability, good electrical properties, and low weight. Polycarbonates are known to be protected from the deleterious effects of UV-A and/or UV-B irradiation with a variety of stabilizer compositions that are well known to those skilled in the art. Accordingly, it would be desirous if polycarbonate materials were resistant to discoloration due to UV irradiation at wavelengths below 300 nm.

The intention of this experiment is to see if similar trends are observed from the polypropylene studies exemplified above, where phosphite compounds not having an —OAr group attached directly to the P atom made a significant impact in polypropylene after UV-C exposure.

The study in this example was performed using LUPOY™ 1201 10P natural polycarbonate (LG Chemical) (PC) as the base resin. The amounts of additives used in PC are described in terms of weight percentages (wt. %) and are described this way throughout. Extrusion is performed on the Killion single screw at 550° F. (˜290° C.) melt temperature. The temperature zones were 480° F., 525° F., 550° F., and 550° F. at the nozzle. Injection molding is performed on an Engel machine at 295° C. The temperature zones were 275° C., 285° C., 295° C., and 295° C. at the nozzle. All samples are dried in a vacuum oven for a minimum of 4 hours and cooled in a sealed glass jar for 1 hour before mixing with additives and adding into an extruder. Samples are prepared and exposed as 2×2×0.125 inch plaques.

UVC exposure at 254 nm is performed with an in-house chamber equipped with two low pressure mercury light sources and a calibrated radiometer to measure irradiance over time. The average irradiance for exposed samples is ˜1.5 mW/cm². The average temperature is about 30° C. Color was measured on a Ci7800 Spectrophotometer calibrated to the Hunter LAB scale using a D65 illuminant at 10° viewer angle. Color is measured on a Ci7800 Spectrophotometer calibrated to the Hunter LAB scale using a D65 illuminant at 10° viewer angle.

Table 7 lists the various formulations considered in the study.

TABLE 7
UV-C Weathering Performance of Polycarbonate with Various Phosphites.

| Formulation | Antioxidant (loading %) | Description |
|---|---|---|
| 7-1 | — | Blank control |
| 7-2 | IRGANOX 168 (0.15%) | Lower 168 loading |
| 7-3 | IRGANOX 168 (0.25%) | Higher 168 loading |
| 7-4 | ULTRANOX 626 (0.15%) | Lower 626 loading |
| 7-5 | ULTRANOX 626 (0.25%) | Higher 626 loading |
| 7-6 | WESTON 618 (0.15%) | Lower 618 loading |
| 7-7 | WESTON 618 (0.25%) | Higher 618 loading |
| 7-8 | DOVERPHOS 9228 (0.15%) | Lower 9228 loading |
| 7-9 | DOVERPHOS 9228 (0.25%) | Higher 9228 loading |

These experiments demonstrate that PC quickly yellowed under 254 nm UVC exposure. Yellowing is clearly visible in each sample after 8 hours of UVC exposure. The type and loading of phosphite does not appear to have a significant impact on discoloration properties compared to the control, and the YI number after 8 hours is from 11-13 on all formulations tested. Regarding color change, it appears that higher loadings of 168 resulted in slightly higher total color change, but the differences are so minor (within 1/10^{th} of a unit), that it's unlikely significant. In fact, all samples tested show a total color change after 8 hours of exposure of between ˜3 and ˜3.15 units.

Ultimately, there are no clear benefits observed from using bulk stabilizers in mitigating discoloration in polycarbonate materials after 254 nm UV-C exposure, which is different than what is observed in polypropylene above.

Accordingly, these studies demonstrate as a whole that it cannot be inferred that the stabilizer additives beneficial or useful in preventing the deleterious effects to polymer compositions upon exposure to UV-A and/or UV-B will also be beneficial or useful for preventing such effects from UV-C exposure. Indeed, even the same stabilizer system as between different polymeric materials can provide insufficient results.

We claim:

1. A polymer composition for making a stabilized polymeric article that is resistant to discoloration upon exposure to UV-C (190-280 nm) light, the polymer composition comprising:
i) an organic polymeric material; and
ii) a hindered phenol, an organic phosphite, or a combination thereof, with the provisos that:
a) the OH group on the aromatic ring of the hindered phenol is flanked by tertiary-hydrocarbyl groups, and
b) the organic phosphite does not have any —OAr group linked directly to the P atom of the phosphite, wherein Ar represents an unsubstituted or substituted aryl group,
even in the absence of other polymer additives including UV absorbers, hindered amine light stabilizers (HALS), metal oxides and/or barium salts.

2. The polymer composition of claim 1, wherein reduced discoloration is associated with the use of specific hindered phenols and the organic phosphites compared to other hindered phenols and organic phosphites.

3. The polymer composition of claim 1, wherein the organic polymeric material is at least one of polyolefins, thermoplastic olefins (TPO), poly(ethylene-vinyl acetate) (EVA), polyesters, polyethers, polyketones, polyamides, natural and synthetic rubbers, polyurethanes, polystyrenes, polyacrylates, polymethacrylates, polybutyl acrylates, polyacetals, polyacrylonitriles, polybutadienes, acrylonitrile-butadiene-styrene (ABS), styrene-acrylonitrile (SAN), acrylonitrile-styrene-acrylate (ASA), cellulosic acetate butyrate, cellulosic polymers, polyimides, polyamideimides, polyetherimides, polyphenylene sulfides, polyphenylene oxides, polysulfones, polyethersulfones, polyvinyl chlorides, amino resin cross-linked polyacrylates and polyesters, polyisocyanate cross-linked polyesters and polyacrylates, phenol/formaldehyde, urea/formaldehyde and melamine/formaldehyde resins, alkyd resins, polyester resins, acrylate resins cross-linked with melamine resins, urea resins, isocyanates, isocyanurates, carbamates, or epoxy resins, cross-linked epoxy resins derived from aliphatic, cycloaliphatic, heterocyclic, and aromatic glycidyl ethers, which are cross-linked with anhydrides or amines, polysiloxanes, Michael addition polymers, addition polymers of amines or blocked amines with activated unsaturated and activated methylene compounds, addition polymers of ketimines with activated unsaturated and activated methylene compounds, polyketimines in combination with unsaturated acrylic polyacetoacetate resins, coating compositions, radiation curable compositions, epoxy melamine resins, organic dyes, cosmetics, cellulose based paper, photographic film paper, fibers, waxes, or inks.

4. The polymer composition of claim 1, wherein the organic polymeric material is at least one of (i) polyethylene, polypropylene, polyisobutylene, polybut-1-ene, or poly-4-methylpent-1-ene; (ii) polyisoprene or polybutadiene; (iii) cyclopentene or norbornene; (iv) optionally crosslinked polyethylene, high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), very low density polyethylene (VLDPE), or ultralow density polyethylene (ULDPE); (v) thermoplastic olefins (TPO); or (vi) copolymers of at least one of mono-, di-, or cyclo-olefins.

5. The polymer composition of claim 4, wherein the organic polymeric material is polyethylene, polypropylene, or thermoplastic olefins.

6. The polymer composition of claim 1, wherein the amount of hindered phenol, organic phosphite, or combination thereof is from 0.001 to 5.0% by weight of the total weight of the polymer composition.

7. The polymer composition of claim 6, wherein the amount of hindered phenol, organic phosphite, or combination thereof is from 0.005 to 3.0% by weight of the total weight of the polymer composition.

8. The polymer composition of claim 7, wherein the amount of hindered phenol, organic phosphite, or combination thereof is from 0.01 to 1.0% by weight of the total weight of the polymer composition.

9. The polymer composition of claim 1, wherein the hindered phenol has at least one group according to Formulae (IVa), (IVb), or (IVc): 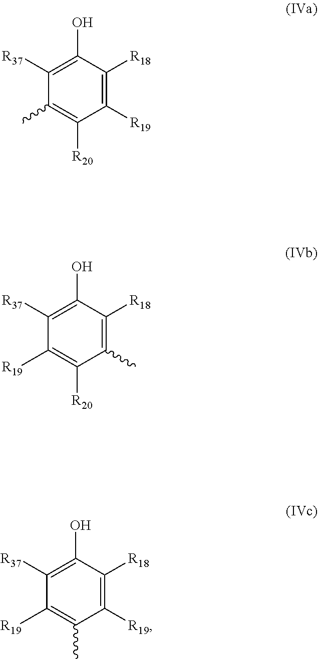
wherein:
“ [symbol] ” indicates the point of attachment (via a carbon-carbon single bond) of the molecular fragment to a parent compound;
R₁₈ and R₃₇ of Formulae (IVa), (IVb), or (IVc) are each independently a C₄₋₁₂ tertiary hydrocarbyl; and
R₁₉ and R₂₀ of Formulae (IVa), (IVb), or (IVc) are each independently hydrogen or C₁-C₂₀ hydrocarbyl.

10. The polymer composition of claim 9, wherein R₁₈ and R₃₇ of Formulae (IVa), (IVb), and (IVc) are each independently tert-butyl, 1,1-dimethylethyl, 1-methylcyclohexyl, or α,α-dimethylbenzyl.

11. The polymer composition of claim 1, wherein the hindered phenol is at least one of:
3,5-di-tert-butyl-4-hydroxyanisole,
3,5-di-tert-butyl-4-hydroxyphenyl stearate,
bis(3,5-di-tert-butyl-4-hydroxyphenyl) adipate,
4,4′-methylenebis (2,6-di-tert-butylphenol),
2,2-bis(3,5-di-tert-butyl-4-hydroxyphenyl)propane,
3,5,3′,5′-tetra-tert-butyl-4,4′-dihydroxydibenzyl ether,
tris(3,5-di-tert-butyl-4-hydroxybenzyl)amine,
bis(3,5-di-tert-butyl-4-hydroxybenzyl) sulfide,
isooctyl 3,5-di-tert-butyl 4-hydroxybenzylmercaptoacetate,
didodecylmercaptoethyl 2,2-bis(3,5-di-tert-butyl-4-hydroxybenzyl)malonate,
di-[4-(1,1,3,3-tetramethylbutyl)phenyl]-2,2-bis(3,5-di-tert-butyl-4-hydroxybenzyl)malonate,
1,3,5-tris(3,5-di-tert-butyl-4-hydroxybenzyl)-2,4,6-trimethylbenzene,
1,4-bis(3,5-di-tert-butyl-4-hydroxybenzyl)-2,3,5,6-tetramethylbenzene,
2,4,6-tris-(3,5-di-tert-butyl-4-hydroxybenzyl)phenol,
2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine,
2-octylmercapto-4,6-bis (3,5-di-tert-butyl-4-hydroxyphenoxy)-1,3,5-triazine,
2,4,6-tris(3,5-di-tert-butyl-4-hydroxyphenoxy)-1,2,3-triazine,
1,3,5-tris(3,5-di-tert-butyl-4-hydroxybenzyl)isocyanurate,
2,4,6-tris(3,5-di-tert-butyl-4-hydroxyphenylethyl)-1,3,5-triazine,
1,3,5-tris(3,5-di-tert-butyl-4-hydroxyphenyl-propionyl)hexahydro-1,3,5-tri azine,
amides of β-(3,5-di-tert-butyl-4-hydroxyphenyl)propionic acid,
N,N′-bis(3,5-di-tert-butyl-4-hydroxyphenylpropionyl)hexamethylenediamine,
N,N′-bis(3,5-di-tert-butyl-4-hydroxyphenylpropionyl)trimethylenediamine,
N,N′-bis(3,5-di-tert-butyl-4-hydroxyphenylpropionyl)hydrazine,
2,6-di-tert-butyl-N,N-dimethylamino-p-cresol,
4,4′-methylenebis(2,6-di-tert-butylphenol),
2,4-bis(n-octylthio)-6-(4-hydroxy-3,5-di-tert-butylanilino)-1,3,5-triazine,
1,6-hexanediyl 3,5-bis(1,1-dimethylethyl)-4-hydroxyphenylpropanoate,
octadecyl 3,5-di-tert-butyl-4-hydroxyhydrocinnamate,
tetrakis[methylene(3,5-di-tert-butyl-4-hydroxyhydrocinnamate)]methane,
esters of 3,5-di-tert-butyl-4-hydroxyphenylacetic acid,
thiodiethylenebis(3,5-di-tert-butyl-4-hydroxy)hydrocinnamate,
1,3,5-trimethyl-2,4,6-tris(3,5-di-tert-butyl-4-hydroxybenzyl)benzene, or
1,3,5-tris(3,5-di-tert-butyl-4-hydroxybenzyl)isocyanurate.

12. The polymer composition of claim 1, wherein the hindered phenol is at least one of pentaerythritol tetrakis(3-(3,5-di-tert-butyl-4-hydroxyphenyl)propionate) (IRGANOX™ 1010), octadecyl 3-(3,5-di-tert-butyl-4-hydroxyphenyl)propionate (IRGANOX™ 1076), 1,3,5-tris(3,5-di-tert-butyl-4-hydroxybenzyl)-1,3,5-triazine-2,4,6-(1H,3H,5H)-trione (IRGANOX™ 3114), or N,N′-bis(3,5-di-butyl-4-hydroxylphenyl propionyl)hydrazine (IRGANOX™ 1024).

13. The polymer composition of claim 1, wherein the organic phosphite is at least one of:
P(OR₁₇)₃, wherein each R₁₇ is independently C₁-C₂₄ alkyl, C₃-C₂₀ cycloalkyl, or C₄-C₂₀ alkylcycloalkyl; 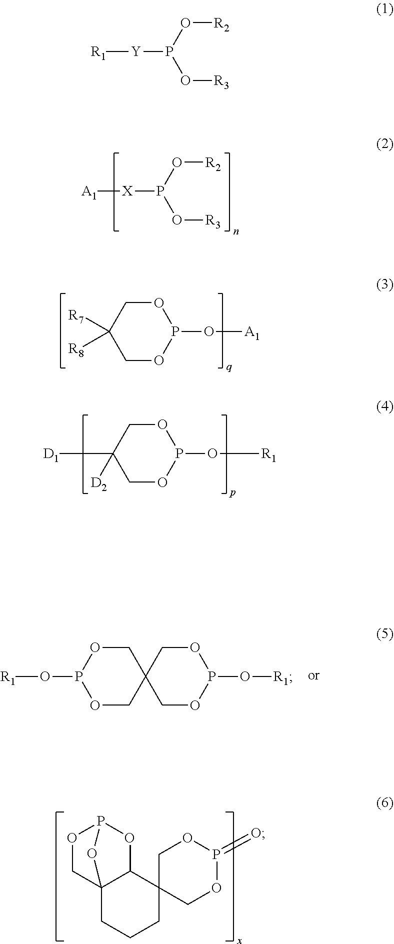
wherein:
the indices are integral and n is 2, 3 or 4; p is 1 or 2; q is 2 or 3; and z is 1 to 6;
X and Y are each oxygen;
A₁, if n or q is 2, is C₂-C₁₈ alkylene; C₂-C₁₂ alkylene interrupted by oxygen, sulfur or
—NR₄—, or a divalent radical of the formula: 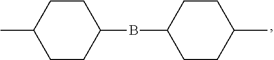
wherein B is a direct bond, —CH₂—, —CHR₄—, —CR₁R₄—, —S—, C₅-C₇ cycloalkylidene, or cyclohexylidene which is substituted by from 1 to 4 C₁-C₄ alkyl in position 3, 4 and/or 5;
A₁, if n or q is 3, is a trivalent carbon-centered radical of the formula CᵣH₂ᵣ₋₁, wherein r is an integer r from 4 to 12;
A₁, if n is 4, is a tetravalent radical of the formula: 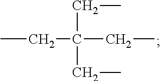
D₁, if p is 1, is C₁-C₄ alkyl and, if p is 2, is —CH₂OCH₂—;
D₂ is C₁-C₄ alkyl;
Q is the radical of an at least z-valent mono- or poly-alcohol, this radical being attached via the oxygen atom of the OH group of the mono- or poly-alcohol to the phosphorus atom;
R₁, R₂ and R₃ are each independently C₁-C₂₄ alkyl which is unsubstituted or substituted by halogen, —COOR₄, —CN or —CONR₄R₄, C₂-C₁₈ alkyl interrupted by oxygen, sulfur or —NR₄—, or C₅-C₁₂ cycloalkyl;
each R₄ is independently hydrogen, C₁-C₈ alkyl, or C₅-C₁₂ cycloalkyl;
R₇ and R₈, if q is 2, are each independently C₁-C₄ alkyl or together are a 2,3-dehydropentamethylene radical; and
R₇ and R₈, if q is 3, are methyl.

14. The polymer composition of claim 1, wherein the organic phosphite is at least one of trilauryl phosphite, trioctadecyl phosphite, tristearyl sorbityl triphosphite, or a phosphite of the formula:

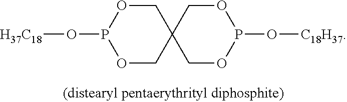

15. The polymer composition of claim 1, wherein the polymer composition further comprises 0.001 to 10 wt. %, preferably 0.01 to 5 wt. %, and more preferably from 0.02 to 2.5 wt. %, based on the weight of the organic polymer, of at least one hindered amine light stabilizer (HALS), UV absorber (UVA), hindered benzoate, thiosynergist, nickel phenolate, hydroxylamine, benzofuranone, nitrone, or inorganic UV screener.

16. A polymer composition of claim 1, further comprising a hindered amine light stabilizer (HALS) having at least one group according to Formula (II): 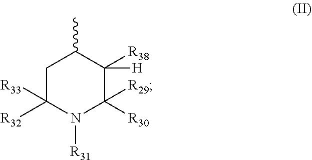
wherein:
R₃₁ is hydrogen, OH, C₁-C₂₀ hydrocarbyl, —CH₂CN, C₁-C₁₂ acyl, or C₁-C₁₈ alkoxy;
R₃₈ is hydrogen or C₁-C₈ hydrocarbyl; and
R₂₉, R₃₀, R₃₂, and R₃₃ are each independently C₁-C₂₀ hydrocarbyl, or R₂₉ and R₃₀ and/or R₃₂ and R₃₃ taken together with the carbon to which they are attached form a C₅-C₁₀ cycloalkyl; or
a group according to Formula (IIa): 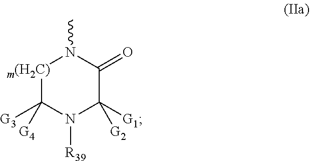
wherein:
m is an integer from 1 to 2;
R₃₉ is hydrogen, OH, C₁-C₂₀ hydrocarbyl, —CH₂CN, C₁-C₁₂ acyl, or C₁-C₁₈ alkoxy; and
G₁-G₄ are each independently C₁-C₂₀ hydrocarbyl.

17. The polymer composition of claim 16, wherein the hindered amine light stabilizer (HALS) is at least one of:
bis(2,2,6,6-tetramethylpiperidin-4-yl) sebacate (TINUVIN™ 770);
bis(2,2,6,6-tetramethylpiperidin-4-yl) succinate;
bis(1,2,2,6,6-pentamethylpiperidin-4-yl) sebacate;
bis(1-octyloxy-2,2,6,6-tetramethylpiperidyl) succinate;
bis(1-octyloxy-2,2,6,6-tetramethylpiperidin-4-yl) sebacate (TINUVIN™ 123);
bis(1,2,2,6,6-pentamethylpiperidin-4-yl) n-butyl 3,5-di-tert-butyl-4-hydroxybenzylmalonate;
a condensate of 1-(2-hydroxyethyl)-2,2,6,6-tetramethyl-4-hydroxypiperidine and succinic acid (TINUVIN™ 622);
2,2,6,6-tetramethylpiperidin-4-yl stearate;
2,2,6,6-tetramethylpiperidin-4-yl dodecanoate;
1,2,2,6,6-pentamethylpiperidin-4-yl stearate;
1,2,2,6,6-pentamethylpiperidin-4-yl dodecanoate;
a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);
tris(2,2,6,6-tetramethylpiperidin-4-yl) nitrilotriacetate;
4-stearyloxy-2,2,6,6-tetramethylpiperidine;
a condensate of N,N′-bis(2,2,6,6-tetramethylpiperidin-4-yl)hexamethylenediamine and 4-morpholino-2,6-dichloro-1,3,5-triazine (CYASORB™ UV-3346);
a condensate of N,N′-bis(2,2,6,6-tetramethylpiperidin-4-yl)hexamethylenediamine and 4-morpholino-2,6-dichloro-1,3,5-triazine, methylated (CYASORB™ UV-3529);
a condensate of 2-chloro-4,6-bis(4-n-butylamino-2,2,6,6-tetramethylpiperidyl)-1,3,5-triazine and 1,2-bis(3-aminopropylamino)ethane (CHIMASSORB™ 119);
a condensate of 2-chloro-4,6-bis(4-n-butylamino-1,2,2,6,6-pentamethylpiperidyl)-1,3,5-triazine and 1,2-bis-(3-aminopropylamino)ethane;
a condensate of N,N′-bis(2,2,6,6-tetramethylpiperidin-4-yl)hexamethylenediamine, 2,2,6,6-tetramethyl-4-n-butylaminopiperidine, di-n-butyl amine, and 2,4,6-trichloro-1,3,5-triazine (CHIMASSORB™ 2020);
a mixture of 4-hexadecyloxy- and 4-stearyloxy-2,2,6,6-tetramethylpiperidine;
a mixture of 4-hexadecyloxy- and 4-stearyloxy-1,2,2,6,6-pentamethylpiperidine;
a condensate of N,N′-bis(2,2,6,6-tetramethylpiperidin-4-yl)hexamethylenediamine and 4-cyclohexylamino-2,6-dichloro-1,3,5-triazine;
a condensate of 1,2-bis(3-aminopropylamino)ethane, 2,4,6-trichloro-1,3,5-triazine, and 4-n-butylamino-2,2,6,6-tetramethylpiperidine;
a condensate of N,N′-bis(2,2,6,6-tetramethylpiperidin-4-yl)hexamethylenediamine and 4-cyclohexylamino-2,6-dichloro-1,3,5-triazine;
tetrakis(2,2,6,6-tetramethylpiperidin-4-yl)-1,2,3,4-butanetetracarboxylate;
tetrakis(1,2,2,6,6-pentamethylpiperidin-4-yl)-1,2,3,4-butanetetracarboxylate;
1,2,3,4-butanetetracarboxylic acid, 2,2,6,6-tetramethylpiperidin-4-yl tridecyl ester;
1,2,3,4-butanetetracarboxylic acid, 1,2,2,6,6-pentamethylpiperidin-4-yl tridecyl ester;
N,N′-1,6-hexanediylbis[N-(2,2,6,6-tetramethylpiperidin-4-yl)formamide (UVINUL™ 4050);
a condensate of N,N′-bis(2,2,6,6-tetramethylpiperidin-4-yl)hexamethylenediamine and 4-tert-octylamino-2,6-dichloro-1,3,5-triazine (CHIMASSORB™ 944);
a condensate of N,N′-bis(2,2,6,6-tetramethyl-1-(propyloxy)-piperidin-4-yl)hexamethylenediamine, 1-propyloxy-2,2,6,6-tetramethyl-4-n-butylaminopiperidine, di-n-butyl amine, and 2,4,6-trichloro-1,3,5-triazine (TINUVIN™ NOR HALS 371);
N,N′-bis(2,2,6,6-tetramethylpiperidin-4-yl)hexamethylenediamine, polymer with 2,4,6-trichloro-1,3,5-triazine, reaction products with 3-bromo-1-propene, di-n-butylamine, and 2,2,6,6-tetramethyl-4-n-butylpiperidine, oxidized, and hydrogenated (TINUVIN™ XT 200);
TINUVIN™ XT-850/XT-855; or
N¹,N^{1′}-1,2-ethanediylbis(1,3-propanediamine), reaction products with cyclohexane and peroxidized N-butyl-2,2,6,6-tetramethyl-4-piperidinamine-2,4,6-trichloro-1,3,5-triazine (FLAMESTAB™ NOR 116).

18. The polymer composition of claim 1, further comprising at least one UV absorber chosen from 2-(2′-hydroxyphenyl)-s-triazine, 2-hydroxybenzophenone, 2-(2′-hydroxyphenyl)benzotriazole, or benzoxazinone.

19. The polymer composition of claim 1, further comprising at least one 2-(2′-hydroxyphenyl)-s-triazine according to Formula (I): 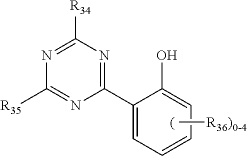
(I),
wherein each of R₃₄ and R₃₅ is independently a C₆-C₁₀ aryl group, mono- or di-C₁-C₁₂ hydrocarbyl-substituted amino, C₂-C₁₂ alkanoyl, C₁-C₁₂ alkyl, C₁-C₁₀ acyl, or C₁-C₁₀ alkoxyl,
wherein the C₆-C₁₀ aryl group is optionally substituted at from 1 to 3 substitutable positions with at least one of OH, halogen, C₁-C₁₂ alkyl, C₁-C₁₂ alkoxy, C₁₋₁₂ alkoxyester, C₂₋₁₂ alkanoyl, or phenyl, wherein the phenyl is optionally substituted at from 1 to 3 substitutable positions with at least one of OH, halogen, C₁₋₁₂ alkyl, C₁₋₁₂ alkoxy, C₁₋₁₂ alkoxyester, or C₂₋₁₂ alkanoyl; and
each R₃₆ is independently OH, halogen, C₁-C₁₂ alkyl, C₁-C₁₂ alkoxy, C₁-C₁₂ alkoxyester, C₂-C₁₂ alkanoyl, phenyl, or C₁-C₁₂ acyl.

20. The polymer composition of claim 19, wherein the 2-(2′-hydroxyphenyl)-s-triazine is at least one of 4,6-bis-(2,4-dimethylphenyl)-2-(2-hydroxy-4-octyloxyphenyl)-s-triazine (CYASORB™ 1164), 2,4-bis[2-hydroxy-4-(2-hydroxy-4-(2-hydroxy-ethoxy)phenyl]-6-(2,4-dimethylphenyl)-s-triazine, 2,4-bis(4-biphenylyl)-6-[2-hydroxy-4-[(octyloxycarbonyl)ethylideneoxy]phenyl]-s-triazine, 2,4-bis(4-biphenylyl)-6-[2-hydroxy-4-(2-ethylhexyloxy)phenyl]-s-triazine (TINUVIN™ 1600), 2,4,6-tris[2-hydroxy-4-(3-sec-butyloxy-2-hydroxypropyloxy)-phenyl]-s-triazine, mixture of 4,6-bis-(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine (TINUVIN™ 400), 4,6-bis-(2,4-dimethylphenyl)-2-(2-hydroxy-4(3-(2-ethylhexyloxy)-2-hydroxypropoxy)-phenyl)-s-triazine, or 4,6-diphenyl-2-(4-hexyloxy-2-hydroxyphenyl)-s-triazine (TINUVIN™ 1577).

21. The polymer composition of claim 18, wherein the 2-hydroxybenzophenone is at least one of 2-hydroxy-4-methoxybenzophenone (CYASORB™ UV-9), 2,2′-dihydroxy-4-methoxybenzophenone (CYASORB™ UV-24), 2-hydroxy-4-octyloxybenzophenone (CYASORB™ UV-531), 2,2′-dihydroxy-4,4′-di-methoxybenzophenone, 2,2′-dihydroxybenzophenone, 2,2′,4,4′-tetrahydroxybenzophenone, 2,2′-dihydroxy-4,4′-dimethoxybenzophenone, 2,2′-dihydroxy-4,4′-diethoxybenzophenone, 2,2′-dihydroxy-4,4′-dipropoxybenzophenone, 2,2′-dihydroxy-4,4′-dibutoxybenzophenone, 2,2′-dihydroxy-4-methoxy-4′-ethoxybenzophenone, 2,2′-dihydroxy-4-methoxy-4′-propoxybenzophenone, 2,2′-dihydroxy-4-methoxy-4′-butoxybenzophenone, 2,2′-dihydroxy-4-ethoxy-4′-propoxybenzophenone, 2,2′-dihydroxy-4-ethoxy-4′-butoxybenzophenone, 2,3′-dihydroxy-4,4′-dimethoxybenzophenone, 2,3′-dihydroxy-4-methoxy-4′-butoxybenzophenone, 2-hydroxy-4,4′,5′-trimethoxybenzophenone, 2-hydroxy-4,4′,6′-tributoxybenzophenone, 2-hydroxy-4-butoxy-4′,5′-dimethoxybenzophenone, 2-hydroxy-4-ethoxy-2′,4′-dibutylbenzophenone, 2-hydroxy-4-propoxy-4′,6′-dichlorobenzophenone, 2-hydroxy-4-propoxy-4′,6′-dibromobenzophenone, 2,4-dihydroxybenzophenone, 2-hydroxy-4-ethoxybenzophenone, 2-hydroxy-4-propoxybenzophenone, 2-hydroxy-4-butoxybenzophenone, 2-hydroxy-4-methoxy-4′-methylbenzophenone, 2-hydroxy-4-methoxy-4′-ethylbenzophenone, 2-hydroxy-4-methoxy-4′-propylbenzophenone, 2-hydroxy-4-methoxy-4′-butylbenzophenone, 2-hydroxy-4-methoxy-4′-tert-butylbenzophenone, 2-hydroxy-4-methoxy-4′-chlorobenzophenone, 2-hydroxy-4-methoxy-2′-chlorobenzophenone, 2-hydroxy-4-methoxy-4′-bromobenzophenone, 2-hydroxy-4,4′-dimethoxybenzophenone, 2-hydroxy-4,4′-dimethoxy-3-methylbenzophenone, 2-hydroxy-4,4′-dimethoxy-2′-ethylbenzophenone, 2-hydroxy-4,4′,5′-trimethoxybenzophenone, 2-hydroxy-4-ethoxy-4′-methylbenzophenone, 2-hydroxy-4-ethoxy-4′-ethylbenzophenone, 2-hydroxy-4-ethoxy-4′-propylbenzophenone, 2-hydroxy-4-ethoxy-4′-butylbenzophenone, 2-hydroxy-4-ethoxy-4′-methoxybenzophenone, 2-hydroxy-4,4′-diethoxybenzophenone, 2-hydroxy-4-ethoxy-4′-propoxybenzophenone, 2-hydroxy-4-ethoxy-4′-butoxybenzophenone, 2-hydroxy-4-ethoxy-4′-chlorobenzophenone, or 2-hydroxy-4-ethoxy-4′-bromobenzophenone.

22. The polymer composition of claim 18, wherein the 2-(2′-hydroxyphenyl)benzotriazole is at least one of 2-(2′-hydroxy-5′-methylphenyl)benzotriazole (TINUVIN™ P), 2-(2′-hydroxy-5′-tert-butylphenyl)benzotriazole, 2-(2′-hydroxy-3′-methyl-5′-tert-butylphenyl)benzotriazole, 2-(2′-hydroxy-5′-cyclohexylphenyl)benzotriazole, 2-(2′-hydroxy-3′,5′-dimethylphenyl)benzotriazole, 2-(2′-hydroxy-5′-tert-butylphenyl)-5-chloro-benzotriazole, 2-(2′-hydroxy-5′-tert-octylphenyl)benzotriazole (CYASORB™ UV-5411), 2-(3′,5′-di-tert-butyl-2′-hydroxyphenyl)-5-chlorobenzotriazole, 2-(3′,5′-di-tert-amyl-2′-hydroxyphenyl)benzotriazole (CYASORB™ UV-2337), 2-(3′,5′-bis(α,α-dimethylbenzyl)-2′-hydroxyphenyl)benzotriazole (TINUVIN™ 900), 2-(3′-tert-butyl-2′-hydroxy-5′-(2-octyloxycarbonylethyl)phenyl)benzotriazole, 2,2′-methylenebis[4-(1,1,3,3-tetramethylbutyl)-6-benzotriazole-2-ylphenol], the transesterification product of 2-[3′-tert-butyl-5′-(2-methoxycarbonylethyl)-2′-hydroxyphenyl]-2H-benzotriazole with polyethylene glycol 300 (TINUVIN™ 1130), 2-[2′-hydroxy-3′-(α,α-dimethylbenzyl)-5′-(1,1,3,3-tetramethylbutyl)phenyl]benzotriazole, 5-trifluoromethyl-2-(2-hydroxy-3-α-cumyl-5-tert-octylphenyl)benzotriazole, 2-(2′-hydroxy-5′-(2-hydroxyethyl)phenyl)benzotriazole, 2-(2′-hydroxy-5′-(2-methacryloyloxyethyl)phenyl)benzotriazole, 2-(2′-hydroxy-3′-tert-butyl-5′-methylphenyl)-5-chlorobenzotriazole (TINUVIN™ 326), 2-(3′-sec-butyl-5′-tert-butyl-2′-hydroxyphenyl)benzotriazole, 2-(3′,5′-di-tert-butyl-2′-hydroxyphenyl)benzotriazole, 2-(3′-dodecyl-5′-methyl-2′-hydroxyphenyl)-benzotriazole, 2-(3′-tert-butyl-5′-(2-octyloxycarbonylethyl)-2′-hydroxyphenyl)-5-chlorobenzotriazole, 2-(5′-methyl-2′-hydroxyphenyl)benzotriazole, 2-(5′-tert-butyl-2′-hydroxyphenyl)benzotriazole, or 2-(2′-hydroxy-3′-di-tert-butylphenyl)benzotriazole.

23. The polymer composition of claim 18, wherein the benzoxazinone is at least one of 2-methyl-3,1-benzoxazin-4-one, 2-butyl-3,1-benzoxazin-4-one, 2-phenyl-3,1-benzoxazin-4-one, 2-(1- or 2-naphthyl)-3,1-benzoxazin-4-one, 2-(4-biphenyl)-3,1-benzoxazin-4-one, 2-p-nitrophenyl-3,1-benzoxazin-4-one, 2-m-nitrophenyl-3,1-benzoxazin-4-one, 2-p-benzoylphenyl-3,1-benzoxazin-4-one, 2-p-methoxyphenyl-3,1-benzoxazin-4-one, 2-O-methoxyphenyl-3,1-benzoxazin-4-one, 2-cyclohexyl-3,1-benzoxazin-4-one, 2-p-(or m-)phthalimidephenyl-3,1-benzoxazin-4-one, N-phenyl-4-(3,1-benzoxazin-4-one-2-yl)phthalimide, N-benzoyl-4-(3,1-benzoxazine-4-one-2-yl)aniline, N-benzoyl-N-methyl-4-(3,1-benzoxazin-4-one-2-yl)-aniline, 2-[p-(N-phenylcarbamonyl)phenyl]-3,1-benzoxazin-4-one, 2-[p-(N-phenyl N-methylcarbamoyl)phenyl]-3,1-benzoxazin-4-one, 2,2′-bis(3,1-benzoxazin-4-one), 2,2′-ethylenebis(3,1-benzoxazin-4-one), 2,2′-tetramethylenebis(3,1-benzoxazin-4-one), 2,2′-hexamethylenebis(3,1-benzoxazin-4-one), 2,2′-decamethylenebis(3,1-benzoxazin-4-one), 2,2′-p-phenylenebis(3,1-benzoxazin-4-one) (CYASORB™ UV-3638), 2,2′-m-phenylenebis(3,1-benzoxazin-4-one), 2,2′-(4,4′-diphenylene)bis(3,1-benzoxazin-4-one), 2,2′-(2,6- or 1,5-naphthalene)bis(3,1-benzoxazin-4-one), 2,2′-(2-methyl-p-phenylene)bis(3,1-benzoxazin-4-one), 2,2′-(2-nitro-p-phenylene)bis(3,1-benzoxazin-4-one), 2,2′-(2-chloro-p-phenylene)bis(3,1-benzoxazin-4-one), 2,2′-(1,4-cyclohexylene)bis(3,1-benzoxazin-4-one), N-p-(3,1-benzoxazin-4-on-2-yl)phenyl, 4-(3,1-benzoxazin-4-on-2-yl)phthalimide, N-p-(3,1-benzoxazin-4-on-2-yl)benzoyl, 4-(3,1-benzoxazin-4-on-2-yl)aniline, 1,3,5-tri(3,1-benzoxazin-4-on-2-yl)benzene, 1,3,5-tri(3,1-benzoxazin-4-on-2-yl)naphthalene, or 2,4,6-tri(3,1-benzoxazin-4-on-2-yl)naphthalene.

24. The polymer composition of claim 1, further comprising a hindered benzoate according to Formula (VI): 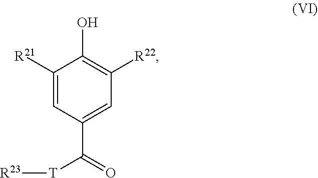
wherein:
each of R²¹ and R²² is independently a C₁-C₁₂ alkyl;
T is O or NR²⁴, wherein R²⁴ is H or a C₁-C₃₀ hydrocarbyl; and
R²³ is H or a C₁-C₃₀ hydrocarbyl.

25. The polymer composition of claim 24, wherein the hindered benzoate is at least one of 2,4-di-tert-butylphenyl-3,5-di-tert-butyl-4-hydroxybenzoate, hexadecyl-3,5-di-tert-butyl-4-hydroxybenzoate (CYASORB™ UV-2908), octadecyl-3,5-di-tert-butyl-4-hydroxybenzoate, octyl-3,5-di-tert-butyl-4-hydroxybenzoate, decyl-3,5-di-tert-butyl-4-hydroxybenzoate, dodecyl-3,5-di-tert-butyl-4-hydroxybenzoate, tetradecyl-3,5-di-tert-butyl-4-hydroxybenzoate, behenyl-3,5-di-tert-butyl-4-hydroxybenzoate, 2-methyl-4,6-di-tert-butylphenyl-3,5-di-tert-butyl-4-hydroxybenzoate, or butyl-3-[3-tert-butyl-4-(3,5-di-tert-butyl-4-hydroxybenzoyloxy)phenyl]propionate.

26. The polymer composition of claim 15, wherein the thiosynergist is at least one of dilauryl 3,3′-thiodipropionate, dimyristyl 3,3′-thiodipropionate, ditridecyl 3,3′-thiodipropionate, distearyl 3,3′-thiodipropionate, pentaerythritol tetrakis-(3-dodecylthiopropionate), a tetraalkyl thioethyl thiodisuccinate, 2,12-dihydroxy-4,10-dithia-7-oxatridecamethylene bis[3-(dodecylthio)propionate], 2-mercaptobenzimidazole, 2-mercaptobenzimidazole, zinc salt, zinc dibutyldithiocarbamate, or dioctadecyl disulfide.

27. The polymer composition of claim 1, further comprising at least one of titanium dioxide, barium sulfate, zinc oxide, or cerium(IV) oxide.

28. A stabilized polymeric article comprising the polymer composition as defined in claim 1.

29. The stabilized polymeric article of claim 28, wherein reduced discoloration is associated with the use of specific hindered phenols and the organic phosphites compared to other hindered phenols and organic phosphites, even in the absence of other polymer additives including UV absorbers, hindered amine light stabilizers (HALS), metal oxides and/or barium salts.

30. A method of reducing discoloration of an organic polymeric material upon exposure to UV-C (190-280 nm) light, comprising adding to the organic polymeric material a stabilizing amount of a hindered phenol, an organic phosphite, or a combination thereof, with the provisos that:
a) the OH group on the aromatic ring of the hindered phenol is flanked by tertiary-hydrocarbyl groups, and
b) the organic phosphite does not have any —OAr group linked directly to the P atom of the phosphite, wherein Ar represents an unsubstituted or substituted aryl group;
wherein reduced discoloration is associated with the use of specific hindered phenols and the organic phosphites compared to other hindered phenols and organic phosphites, even in the absence of other polymer additives including UV absorbers, hindered amine light stabilizers (HALS), metal oxides and/or barium salts.

31. The method of claim 30, wherein the stabilizing amount of the hindered phenol, organic phosphite, or combination thereof is from 0.001 to 5.0% by weight of the total weight of the polymer composition.
